(19) United States
(12) Patent Application Publication
(10) Pub. No.: US 2025/0342174 A1
(43) Pub. Date: Nov. 6, 2025

(54) REPLICATION OF DYNAMIC TABLES

(71) Applicant: Snowflake Inc., Bozeman, MT (US)

(72) Inventors: Chong Han, Bellevue, WA (US); Nithin Mahesh, Kirkland, WA (US); Subramanian Muralidhar, Mercer Island, WA (US); Siddarth Ramadoss, Kirkland, WA (US); Daniel E. Sotolongo, Seattle, WA (US); Boyuan Zhang, Seattle, WA (US); Ying Zhang, Kirkland, WA (US)

(21) Appl. No.: 19/031,161

(22) Filed: Jan. 17, 2025

Related U.S. Application Data
(60) Provisional application No. 63/643,115, filed on May 6, 2024.

(51) Int. Cl. G06F 16/27

(52) U.S. Cl. CPC G06F 16/27

(57) ABSTRACT

Provided herein are systems and methods for dynamic table replication. A method includes configuring a first DT within a first failover group. The method further includes causing replication of the first DT from a primary deployment of a network-based database system to a second DT in a secondary deployment of the network-based database system. The method further includes configuring the second DT as a primary DT in the secondary deployment based on detecting a failover event in the primary deployment. The method further includes performing an automatic refresh of the primary DT in the secondary deployment based on a scheduling state of the first DT in the primary deployment prior to the failover event.

### PRIORITY CLAIM

This application claims the benefit of priority to U.S. Provisional Patent Application 63/643,115, filed May 6, 2024, and entitled “REPLICATION OF DYNAMIC TABLES,” which application is incorporated herein by reference in its entirety.

### TECHNICAL FIELD

Embodiments of the disclosure relate generally to databases and, more specifically, to a database object type (e.g., a dynamic table or DT) and replication of DTs.

### BACKGROUND

Databases are widely used for data storage and access in computing applications. A goal of database storage is to provide enormous sums of information in an organized manner so that it can be accessed, managed, updated, and shared. In a database, data may be organized into rows, columns, and tables. Different database storage systems may be used to store different types of content, such as bibliographic, full text, numeric, and image content. Further, in computing, different database systems may be classified according to the organizational approach of the database. There are many different types of databases, including relational databases, distributed databases, cloud databases, object-oriented databases, and others.

Various entities and companies use databases to store information that may need to be accessed or analyzed. When a query is generated to extract certain organized information from the database, a query statement is executed against the database data. The query returns specific data according to one or more query predicates that indicate what information should be returned by the query. The query extracts specific data from the database and formats that data into a readable form. The query may be written in a language that is understood by the database, such as Structured Query Language (“SQL”), so the database systems can determine what data should be located and how it should be returned. The query may request any pertinent information that is stored within the database. If the appropriate data can be found to respond to the query, the database has the potential to reveal complex trends and activities. This power can be harnessed through the use of a successfully executed query. However, the configuration of queries and consuming changes to queries may be challenging and time-consuming.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based database system in communication with a cloud storage platform, in accordance with some embodiments of the present disclosure.

FIG. 2 is a block diagram illustrating the components of a compute service manager using a DT manager, in accordance with some embodiments of the present disclosure.

FIG. 3 is a block diagram illustrating components of an execution platform, in accordance with some embodiments of the present disclosure.

FIG. 4 is a diagram illustrating an example data enrichment pipeline using dynamic tables (DTs), in accordance with some embodiments of the present disclosure.

FIG. 5 is a diagram of a view graph of DTs associated with different lag targets, in accordance with some embodiments of the present disclosure.

FIG. 6 is a diagram of a task graph of DTs associated with scheduled refreshes at different times according to individual lag targets, in accordance with some embodiments of the present disclosure.

FIG. 7 is a diagram illustrating the use of data manipulation language (DML) commands and time travel queries to compute an updated set of a DT with respect to specific versions of its base relations, in accordance with some embodiments of the present disclosure.

FIG. 8 is a diagram of using a CHANGES clause in connection with query processing, in accordance with some embodiments of the present disclosure.

FIG. 9 is a diagram of a stream object configuration for a table, in accordance with some embodiments of the present disclosure.

FIG. 10 is a diagram of shared views, in accordance with some embodiments of the present disclosure.

FIG. 11 is a diagram of a stream object based on a complex view, in accordance with some embodiments of the present disclosure.

FIG. 12 is a diagram of a view evolution, in accordance with some embodiments of the present disclosure.

FIG. 13 is a diagram of a DT refresh, in accordance with some embodiments of the present disclosure.

FIG. 14 is a diagram illustrating the determination of changes (or delta (Δ)) to a base table for a DT refresh, in accordance with some embodiments of the present disclosure.

FIG. 15 is a diagram illustrating a configuration of a DT in a primary deployment with a dependency failing over to a DT in a secondary deployment, in accordance with some embodiments of the present disclosure.

FIG. 16A is a diagram illustrating a DT that depends on a DT in a secondary deployment, in accordance with some embodiments of the present disclosure.

FIG. 16B is a diagram illustrating DT refresh in connection with database renaming, in accordance with some embodiments of the present disclosure.

FIG. 16C is a diagram illustrating an incremental DT refresh when dependencies are in different failover groups (FGs), in accordance with some embodiments of the present disclosure.

FIG. 17 illustrates a table with DT replication states and DT scheduling states, in accordance with some embodiments of the present disclosure.

FIG. 18 is a diagram of state transitions for a primary DT and a replica DT based on the states of FIG. 17, in accordance with some embodiments of the present disclosure.

FIG. 19 is a diagram of state transitions for a primary DT and a replica DT with added new states, in accordance with some embodiments of the present disclosure.

FIG. 20 is a diagram of state transitions for a primary DT and a replica DT with added new states, in accordance with some embodiments of the present disclosure.

FIG. 21 illustrates a table with dynamic table replication states, in accordance with some embodiments of the present disclosure.

FIG. 22 is a diagram of state transitions based on the states of FIG. 21, in accordance with some embodiments of the present disclosure.

FIG. 23 is a flow diagram illustrating the operations of a database system in performing a method for replicating a dynamic table, in accordance with some embodiments of the present disclosure.

FIG. 24 is a flow diagram illustrating the operations of a database system in performing another method for replicating a dynamic table, in accordance with some embodiments of the present disclosure.

FIG. 25 is a flow diagram illustrating the operations of a database system in performing a method for replicating a dynamic table for a non-failover use case, in accordance with some embodiments of the present disclosure.

FIG. 26 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

In the present disclosure, physical units of data that are stored in a data platform—and that make up the content of, e.g., database tables in customer accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and the like. If stored internally in the data platform, a given file is referred to herein as an “internal file” and may be stored in (or at, or on, etc.) what is referred to herein as an “internal storage location.” If stored external to the data platform, a given file is referred to herein as an “external file” and is referred to as being stored in (or at, or on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, extensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other examples of unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

As used herein, the term “clone” indicates a snapshot of a container and its contained objects. In some aspects, the snapshot time is the most recently committed version. However, by using the BEFORE or AT keywords, a user can specify the version to be cloned. In some aspects, when a clone of a table is generated, a new metadata record is generated, which contains compacted metadata of the table at the clone command's version. In this regard, a clone operation can be configured as a metadata-only operation and can, therefore, be referred to as zero-copy cloning.

As used herein, the term “view” indicates a named SELECT statement, conceptually similar to a table. In some aspects, a view can be secure, which prevents queries from getting information on the underlying data obliquely.

As used herein, the term “materialized view” indicates a view that is eagerly computed rather than lazily (e.g., as a standard view). In some aspects, efficient implementation of materialized views overlaps with change tracking functionality.

As used herein, the term “CHANGES clause” indicates a syntactic modifier on a FROM clause indicating that a SELECT statement should return the changes that occurred to the specified table between two given times. In some aspects, several different change types can be requested:
(a) The default type (also referred to as delta) finds the smallest set of changes that could account for the difference between the tables at the given times;
(b) The append-only type only finds rows that were appended to the table (with subsequent updates or deletions of the row not being recorded); and
(c) The audit type can compute changes made between the given times, even if they cancel out.

In some aspects, DTs can be used to improve functionalities provided by tasks and materialized views (MVs). As used herein, the term “dynamic table” (or DT) indicates data that is the result of a query, which can be periodically updated and queried. Tasks are powerful, but the conceptual model may limit their usability. Most use cases for tasks can be satisfied with tasks combined with stored procedures, streams, DML, and transactions. Streams on views can be used to facilitate stateless incremental computations. Some drawbacks associated with tasks (which can be successfully addressed with DTs) include the following: (a) backfill workflows must be implemented and orchestrated manually, and (b) streams cannot cleanly increment stateful operators (e.g., GroupBy, outer joins, and windows). As used herein, the term “dynamic table” (or DT) is interchangeable with the term “materialized table” (or MT).

In some aspects, MVs can be used as query accelerators. Simple queries may be sufficient, and only aggregating operations are supported (e.g., no joins and no nested views are supported). Additionally, implementation costs may be insignificant, and less visibility and control may be exposed to users.

In some aspects, DTs can be used to target data engineering use cases. While MVs can support only aggregating operations (e.g., a single GroupBy on a single table), DTs remove query limitations and allow joining and nesting in addition to aggregation. Additional benefits of DTs include providing controls over cost and table refresh operations, automating common operations, including incrementalization and backfill, and providing a comprehensive operational experience.

Aspects of the present disclosure provide techniques for replication of database object types (e.g., DTs) for disaster recovery. If a dynamic table is included in failover groups (FGs)/database replication, the dynamic table is replicated from the primary to the secondary deployment. The scheduling state of the secondary replica is set to “SUSPENDED” mode. After a failover, the secondary replica dynamic tables now become primary and can automatically resume refreshing if their original scheduling state prior to replication was in “ACTIVE” mode.

Aspects of the present disclosure provide techniques for replication of DTs for non-failover cases (e.g., for data sharing). Suppose a dynamic table is included in a replication group. In that case, the dynamic table is replicated from the primary to the secondary deployment, and the secondary deployment replica is configured to behave like a regular table. The replicated DTs will not perform any refreshes. When other dynamic tables consume these replicated dynamic tables, they can be configured to behave like regular tables (e.g., consumer DT refreshes will not cause the replicated DT to refresh). The data in the replicated DT can be obtained exclusively from the replication.

The disclosed DT replication techniques are associated with the following advantages over existing replication techniques:
(a) Replicating dynamic tables for disaster recovery allows users with disaster recovery requirements to use dynamic tables in their data pipeline setup.
(b) Replicating dynamic tables for sharing allows users to share data across deployments through dynamic tables, utilizing their ability to automatically refresh data according to the lag specification. In prior use cases that do not rely on the disclosed techniques, users who need this particular use case would need to create streams, tasks, and target tables, which can increase processing overhead and become a use case that is challenging to manage. Moreover, the replication of streams/tasks is associated with their limitations.

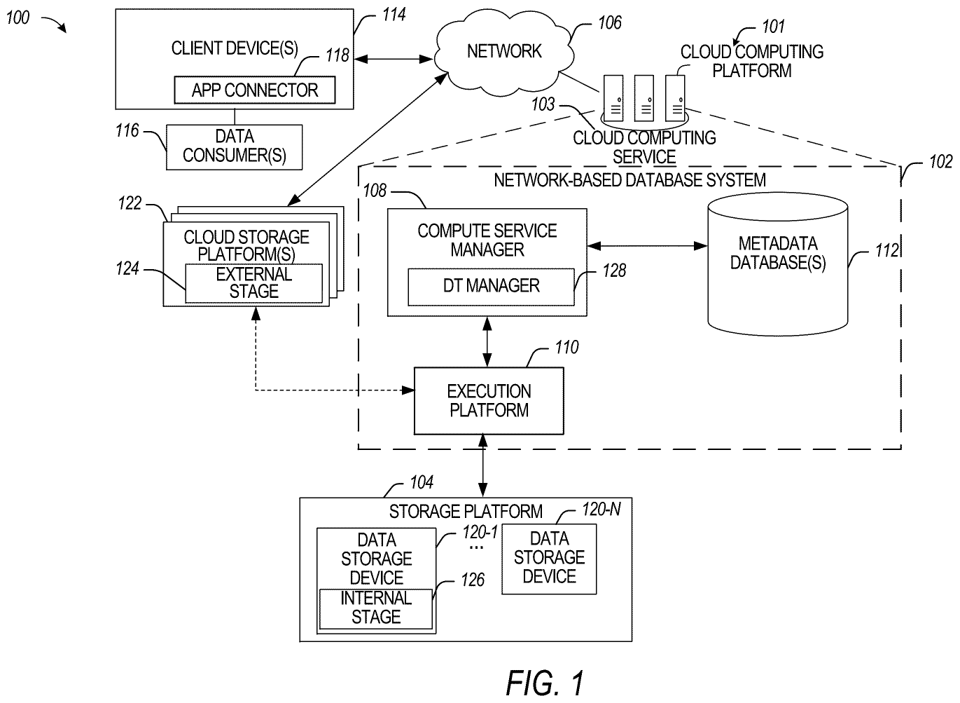

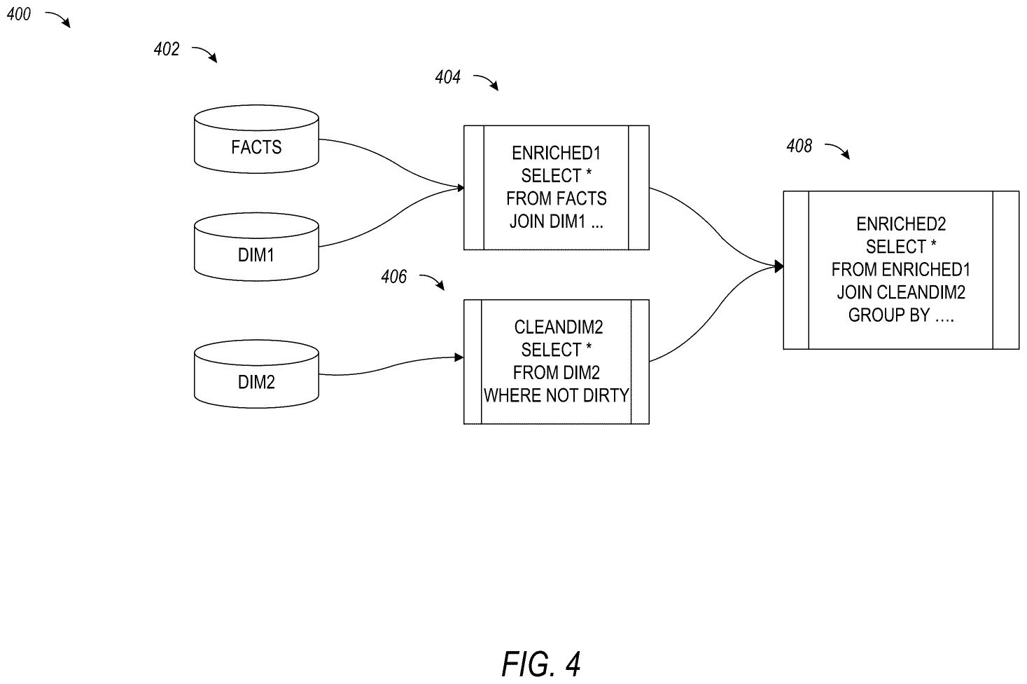

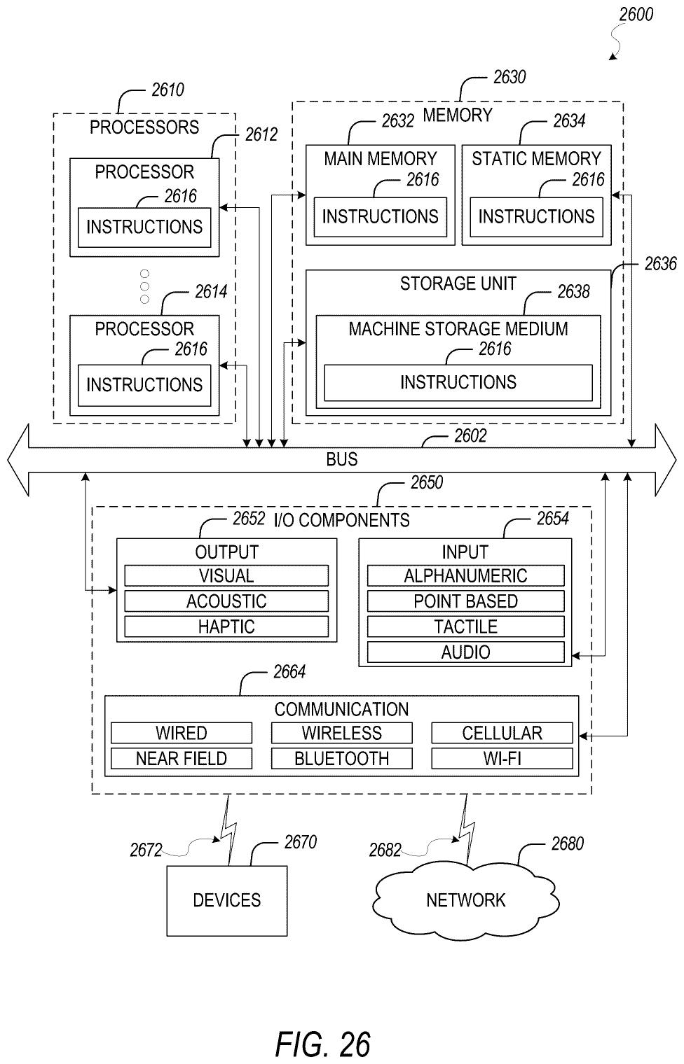

The various embodiments that are described herein are described with reference, where appropriate, to one or more of the various figures. An example computing environment using a DT manager to configure DT replication as well as other DT-related functions (e.g., creating, maintaining, and consuming cost-effective, continuous data pipelines and performing zero-copy clones of DTs) is discussed in connection with FIGS. 1-3. Example configuration and functions associated with the DT manager are discussed in connection with FIGS. 4-25. A more detailed discussion of example computing devices that may be used in connection with the disclosed techniques is provided in connection with FIG. 26.

FIG. 1 illustrates an example computing environment 100 that includes a database system in the example form of a network-based database system 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not explicitly described herein. In other embodiments, the computing environment may comprise another type of network-based database system or a cloud data platform. For example, in some aspects, the computing environment 100 may include a cloud computing platform 101 with the network-based database system 102, storage platforms 104, and cloud storage platforms 122. The cloud computing platform 101 provides computing resources and storage resources that may be acquired (purchased) or leased (e.g., by data providers and data consumers), and configured to execute applications and store data.

The cloud computing platform 101 may host a cloud computing service 103 that facilitates storage of data on the cloud computing platform 101 (e.g., data management and access) and analysis functions (e.g., SQL queries, analysis), as well as other processing capabilities (e.g., performing the DT-related functions described herein). The cloud computing platform 101 may include a three-tier architecture: data storage (e.g., storage platforms 104 and 122), an execution platform 110, and a compute service manager 108 providing cloud services (e.g., services associated with zero-copy cloning of DTs using a DT manager 128).

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files-be they unstructured files, semi-structured files, structured files, and/or files of one or more other types-on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 101 could also use a cloud-storage platform, which is referred to herein as an internal storage location concerning the data platform.

From the perspective of the network-based database system 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and where external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 102 of the cloud computing platform 101 is in communication with the cloud storage platforms 104 and 122 (e.g., AWS®, Microsoft Azure Blob Storage®, or Google Cloud Storage), client device 114 (e.g., a data provider), and data consumer 116 via network 106. The network-based database system 102 is a network-based system used for reporting and analysis of integrated data from one or more disparate sources, including one or more storage locations within the cloud storage platform 104. The storage platform 104 comprises a plurality of computing machines and provides on-demand computer system resources such as data storage and computing power to the network-based database system 102.

The network-based database system 102 comprises a compute service manager 108, an execution platform 110, and one or more metadata databases 112. The network-based database system 102 hosts and provides data reporting and analysis services (as well as additional services such as the disclosed DT-related functions) to multiple client accounts, including an account of the data provider associated with client device 114 and an account of the data consumer 116. In some embodiments, the compute service manager 108 comprises the DT manager 128, which can be used in connection with DT-related functions. Example DT-related functions include configuring DT replication for disaster recovery and DT replication for non-failover use cases (e.g., replication of DTs for data sharing). A more detailed description of the functions provided by the DT manager 128 is provided in connection with FIGS. 4-25.

The compute service manager 108 coordinates and manages operations of the network-based database system 102. The compute service manager 108 also performs query optimization and compilation and manages clusters of computing services that provide compute resources (also referred to as “virtual warehouses”). The compute service manager 108 can support any number of client accounts, such as end-users providing data storage and retrieval requests, accounts of data providers, accounts of data consumers, system administrators managing the systems and methods described herein, and other components/devices that interact with the compute service manager 108.

The compute service manager 108 is also in communication with a client device 114. The client device 114 corresponds to a user of one of the multiple client accounts (e.g., a data provider) supported by the network-based database system 102. The data provider may utilize application connector 118 at the client device 114 to submit data storage, retrieval, and analysis requests to the compute service manager 108 as well as to access or configure other services provided by the compute service manager 108 (e.g., services associated with the disclosed DT-related functions).

Client device 114 (also referred to as user device 114) may include one or more of a laptop computer, a desktop computer, a mobile phone (e.g., a smartphone), a tablet computer, a cloud-hosted computer, cloud-hosted serverless processes, or other computing processes or devices may be used to access services provided by the cloud computing platform 101 (e.g., cloud computing service 103) by way of a network 106, such as the Internet or a private network.

In the description below, actions are ascribed to users, particularly consumers and providers. Such actions shall be understood to be performed concerning client device (or devices) 114 operated by such users. For example, a notification to a user may be understood to be a notification transmitted to the client device 114, input or instruction from a user may be understood to be received by way of the client device 114, and interaction with an interface by a user shall be understood to be interaction with the interface on the client device 114. In addition, database operations (joining, aggregating, analysis, etc.) ascribed to a user (consumer or provider) shall be understood to include performing such actions by the cloud computing service 103 in response to an instruction from that user.

In some aspects, a data consumer 116 can communicate with the client device 114 to access functions offered by the data provider. Additionally, the data consumer can access functions (e.g., DT-related functions) offered by the network-based database system 102 via network 106.

The compute service manager 108 is also coupled to one or more metadata databases 112 that store metadata about various functions and aspects associated with the network-based database system 102 and its users. For example, a metadata database 112 may include a summary of data stored in remote data storage systems as well as data available from a local cache. Additionally, a metadata database 112 may include information regarding how data is organized in remote data storage systems (e.g., the cloud storage platform 104) and the local caches. Information stored by a metadata database 112 allows systems and services to determine whether a piece of data needs to be accessed without loading or accessing the actual data from a storage device.

The compute service manager 108 is further coupled to the execution platform 110, which provides multiple computing resources (e.g., execution nodes) that execute, for example, various data storage, data retrieval, and data processing tasks. The execution platform 110 is coupled to storage platform 104 and cloud storage platforms 122. The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data storage technology. Additionally, the cloud storage platform 104 may include distributed file systems (such as Hadoop Distributed File Systems (HDFS)), object storage systems, and the like. In some embodiments, at least one internal stage 126 may reside on one or more of the data storage devices 120-1-120-N, and at least one external stage 124 may reside on one or more of the cloud storage platforms 122.

In some embodiments, communication links between elements of the computing environment 100 are implemented via one or more data communication networks, such as network 106. The one or more data communication networks may utilize any communication protocol and any communication medium. In some embodiments, the data communication networks are a combination of two or more data communication networks (or sub-networks) coupled with one another. In alternate embodiments, these communication links are implemented using any communication medium and any communication protocol.

The compute service manager 108, metadata database 112, execution platform 110, and storage platform 104 are shown in FIG. 1 as individual discrete components. However, each of the compute service manager 108, metadata database 112, execution platform 110, and storage platforms 104 and 122 may be implemented as a distributed system (e.g., distributed across multiple systems/platforms at multiple geographic locations; also referred to as deployments). Additionally, each of the compute service manager 108, metadata database(s) 112, execution platform 110, and storage platforms 104 and 122 can be scaled up or down (independently of one another) depending on changes to the requests received and the changing needs of the network-based database system 102. Thus, in the described embodiments, the network-based database system 102 is dynamic and supports regular changes to meet the current data processing needs.

During typical operations, the network-based database system 102 processes multiple jobs as determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from and store data to any of the data storage resources in the cloud storage platform 104.

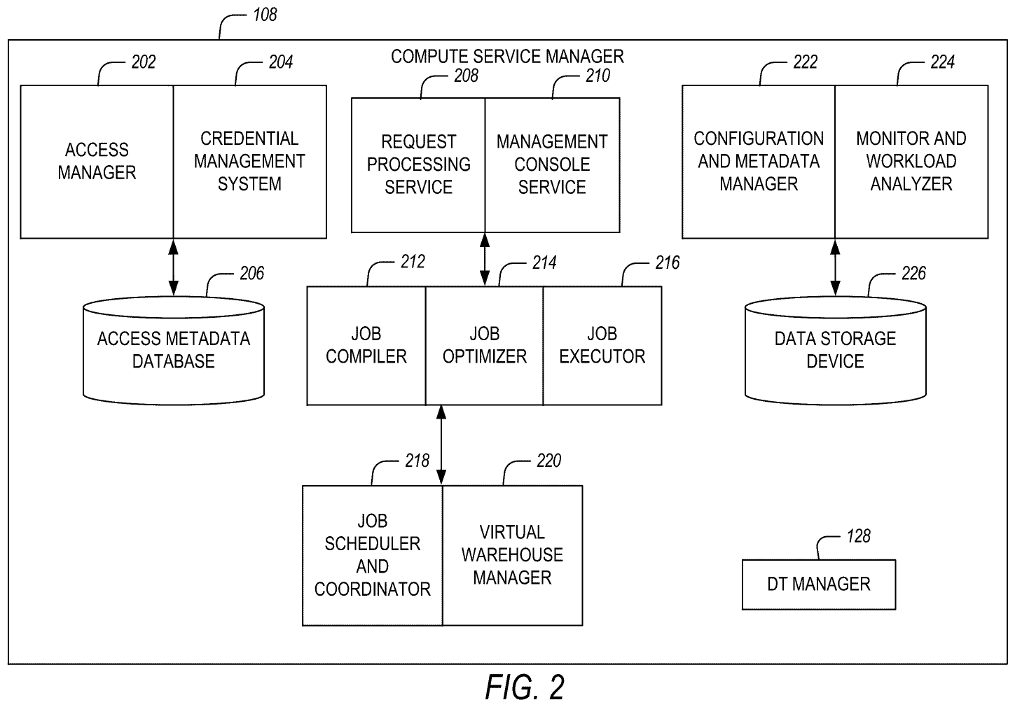

FIG. 2 is a block diagram illustrating components of the compute service manager 108, in accordance with some embodiments of the present disclosure. As shown in FIG. 2, the compute service manager 108 includes an access manager 202 and a credential management system 204 coupled to an access metadata database 206, which is an example of the metadata database(s) 112. Access manager 202 handles authentication and authorization tasks for the systems described herein. The credential management system 204 facilitates the use of remotely stored credentials to access external resources, such as data resources, in a remote storage device. As used herein, the remote storage devices may also be referred to as “persistent storage devices” or “shared storage devices.” For example, the credential management system 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in storage platform 104.

A management console service 210 supports administrators and other system managers' access to various systems and processes. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs, such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes a configuration and metadata manager 222, which manages the information related to the data stored in the remote data storage devices and the local buffers (e.g., the buffers in the execution platform 110). Configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based database system 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based database system 102. For example, data storage device 226 may represent buffers in execution platform 110, storage devices in storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing query A should not be allowed to request access to data source D (e.g., data storage device 226) that is not relevant to query A. Similarly, a given execution node (e.g., execution node 302-1 may need to communicate with another execution node (e.g., execution node 302-2) and should be disallowed from communicating with a third execution node (e.g., execution node 312-1) and any such illicit communication can be recorded (e.g., in a log or other location). Also, the information stored on a given execution node is restricted to data relevant to the current query, and any other data is unusable, rendered so by destruction or encryption where the key is unavailable.

In some embodiments, the compute service manager 108 further includes the DT manager 128, which can be used in connection with DT-related functions disclosed herein.

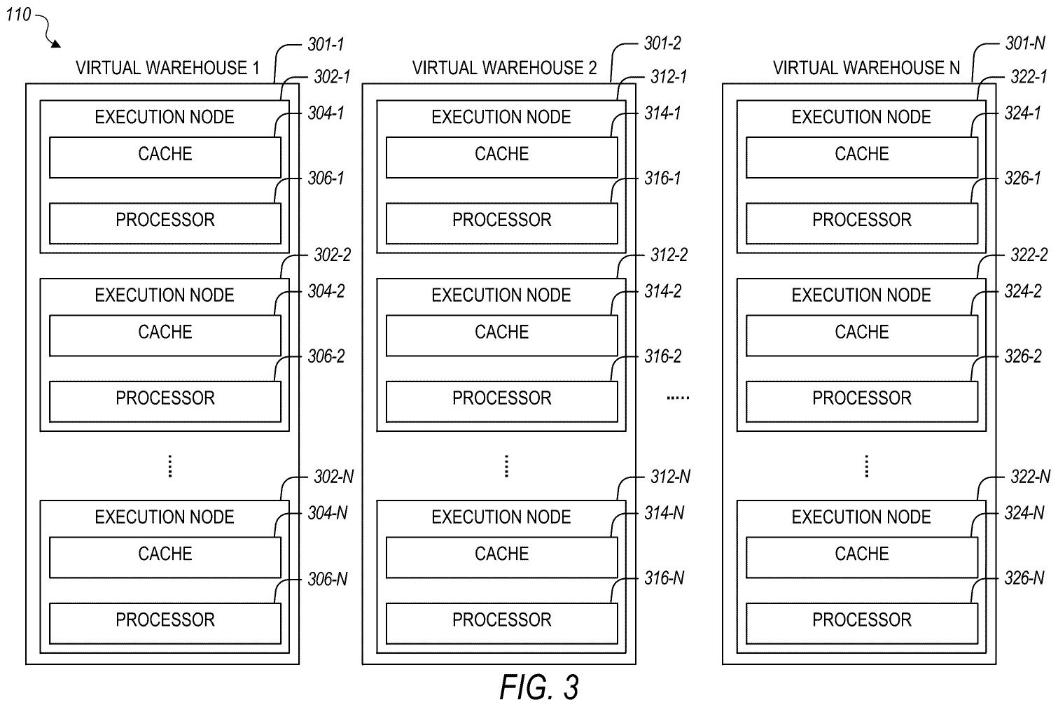

FIG. 3 is a block diagram illustrating components of the execution platform 110, in accordance with some embodiments of the present disclosure. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the cloud storage platform 104).

Although each virtual warehouse shown in FIG. 3 includes three execution nodes, a particular virtual warehouse may include any number of execution nodes. Further, the number of execution nodes in a virtual warehouse is dynamic so that new execution nodes are created when additional demand is present, and existing execution nodes are deleted when they are no longer necessary.

Each virtual warehouse is capable of accessing any of the data storage devices 120-1 to 120-N shown in FIG. 1. Thus, the virtual warehouses are not necessarily assigned to a specific data storage device 120-1 to 120-N and; instead, they can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes: 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes: 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes: 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the cloud storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, which is helpful for tasks that require fast scanning of large amounts of data. In some embodiments, the cache resources and computing resources associated with a particular execution node are determined when the execution node is created based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, virtual warehouses 1, . . . , N may be implemented using multiple computing systems at multiple geographic locations. For example, virtual warehouse 1 can be implemented by a computing system at a first geographic location. In contrast, virtual warehouses 2 and n are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, that virtual warehouse is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in the cloud storage platform 104, but each virtual warehouse has its execution nodes with independent processing and caching resources. This configuration allows requests on different virtual warehouses to be processed independently and with no interference between the requests. This independent processing, combined with the ability to add and remove virtual warehouses dynamically, supports the addition of new processing capacity for new users without impacting the performance observed by the existing users.

In some aspects, DTs can be configured with the following capabilities:
(a) Incremental refresh: selection, projections (scalar functions), aggregations, and joins (inner, outer, semi, anti). In some aspects, DTs are refreshed incrementally (e.g., when the DTs contain the above-listed operations).
(b) Observability: In some aspects, a user interface (UI) with a simple view graph and account usage views can be used for monitoring.
(c) DT definition evolution can be used to configure a full refresh. In some aspects, DTs can continue functioning when they are replaced. However, updating may be based on a full (non-incremental) refresh. If consuming DTs are broken, updates may pause, and an error may be generated.
(d) Shared data: In some aspects, DTs can read shared tables and views and share them themselves.
(e) Data transformation tool (e.g., DBT) integration: a custom DBT materialization for users can be used to adopt DTs in dmldata transformation pipelines.

In some aspects, the disclosed techniques can be used to create DTs with the following configurations: minimum lag of 1 second; nesting depth, fan-in, and fan-out of up to 1000; incremental refreshes for partitioned window functions, subqueries, lateral joins, and recursive queries; integration with other data processing features including streams, row access policies, column masking policies, external tables, directory tables, external functions, user-defined functions (UDFs), and user-defined table functions (UDTFs); support for non-deterministic functions; an interactive UI for monitoring and debugging DT pipelines; incremental DT definition evolution when queries change compatibility; automatic query rewrites into DT scans; stream-like, “append-only” transformations; continuous DML features; merge performance optimizations; and using DTs to implement other features.

In some aspects, DTs can be defined and orchestrated using data definition language (DDL) commands. For example, a DT can be created using the command CREATE DYNAMIC TABLE <name>[LAG=<duration>] AS<query>. In this regard, a DT can be created using a query on one or more base tables and a lag duration (also referred to as a lag or a lag duration value). The lag duration value indicates a maximum period that a result of a prior refresh of the query can lag behind a current real-time instance (e.g., a current time, which can also be referred to as a current time instance). The lag duration value can be configured as a required parameter.

In some aspects, the DDL command ALTER DYNAMIC TABLE <name> {SUSPEND|RESUME} can be used to suspend or resume a refresh (e.g., to prevent refreshes without deleting DTs entirely).

In some aspects, the DDL command ALTER DYNAMIC TABLE <name> REFRESH can be used for the manual orchestration of data pipelines. In some aspects, the DDL command SHOW DYNAMIC TABLES can be similar to the command SHOW DYNAMIC VIEWS but with additional columns to show, e.g., lag, base tables, and maintenance plan. In some aspects, when the lag duration is set to infinity, the ALTER command can be used for a manual refresh.

In some aspects, the following DDL command configurations can be used with the disclosed DT-related techniques.

The following syntax may be used with the CREATE command for creating DTs: CREATE [OR REPLACE] DYNAMIC TABLE <name> (<column_list>) [LAG=<duration>] AS<select>. LAG represents a lag duration that the table is allowed to be behind relative to the current time. The term <select> indicates the view definition and may include a selection of both tables, views, projections (scalar functions), aggregates, joins (inner, outer, semi, anti), etc. This definition can be richer than an MV view definition.

In some aspects, if LAG is not specified and the user provides a view definition that is not compatible with the current implementation, then an informative error is generated that will point to a document that details what is allowed/not allowed. Examples of this include a selection on an MV (selects from materialized tables can be allowed, but not classic MVs). Similar to existing MVs, creation requires CREATE MATERIALIZED TABLE privileges on the schema and SELECT privileges on the base tables and sources.

The following configurations may be used with the ALTER command. The command can be configured as ALTER MATERIALIZED TABLE <name> {SUSPEND|RESUME}. This command allows the user to stop the DT from updating itself via its refresh strategy. A DT can remain suspended until a RESUME is executed.

In some aspects, the command ALTER MATERIALIZED TABLE <name> set LAG=<duration> can be used to change the lag of the materialized table. The subsequent scheduled execution of the refresh can reflect the updated lag.

In some aspects, the command ALTER MATERIALIZED TABLE <name> REFRESH [AT(<at_spec>)] can be used to initiate an immediate refresh of the DT. This command may be used with data engineering use cases that may require more direct control over refreshes. For example, it may be common for imperative data pipelines to spend a significant amount of time in an inconsistent state, with new data only partially loaded. Authors of such pipelines would not want a refresh to occur during these inconsistent periods, and they may disable automatic refresh (LAG=‘infinity’) and invoke REFRESH when they know the database is in a consistent state.

In some aspects, the optional AT clause can be used to allow users to control the transactional time from which the DT's source data is read. Using this, they can ensure that multiple manually-orchestrated DTs are aligned correctly, even during backfills.

In some aspects, commands ALTER DYNAMIC TABLE <name> set REFRESH_MODE={INCREMENTAL|FULL|AUTO} and ALTER DYNAMIC TABLE <name> unset REFRESH_MODE can be used to change the refresh mode on the DT. The change can be reflected in the next reprocessing of the DT. Unset sets the refresh mode back to the system default. The INCREMENTAL value may be used to maintain the DT by processing changes to the source(s) incrementally. The FULL value may be used to perform a full refresh of the DT (i.e., an entire re-computation). The AUTO value indicates that the network-based database system can determine whether to perform an incremental or full refresh, any may alternate between the two depending on upstream changes and the view definition.

In some aspects, the DROP DYNAMIC TABLE <name> command can be configured.

In some aspects, SHOW DYNAMIC TABLES [LIKE ‘<pattern>’][IN {ACCOUNT|DATABASE [<db_name>]|[SCHEMA][<schema_name>]}] command can be configured. The existing syntax can be kept, but the following columns can be added to the existing output:
(a) lag: the user-defined lag duration specified during creation. This configuration can be static, unlike the existing columns.
(b) source_names: a column that has the fully qualified names of the sources used in the DT as a list, ex. [“db”. “schema”. “table”]. For a longer term, source_database_name, source_schema_name, and source_table_name can be deprecated in favor of this new column as these will be null for DTs.

In some aspects, the following variants of the EXPLAIN command may be used in connection with the disclosed DT-related functionalities (e.g., to obtain details of an operation on a DT):
(a) EXPLAIN CREATE DYNAMIC TABLE <mv> LAG=<duration>AS<query> can be used to show the refresh plan before creating a DT.
(b) EXPLAIN ALTER DYNAMIC TABLE <mv> REFRESH [AT(<at_spec>)] can be used to show the refresh plan for an extant DT.
(c) EXPLAIN SELECT <select> FROM <mv> can be used to show the version and plan used to resolve the DT.

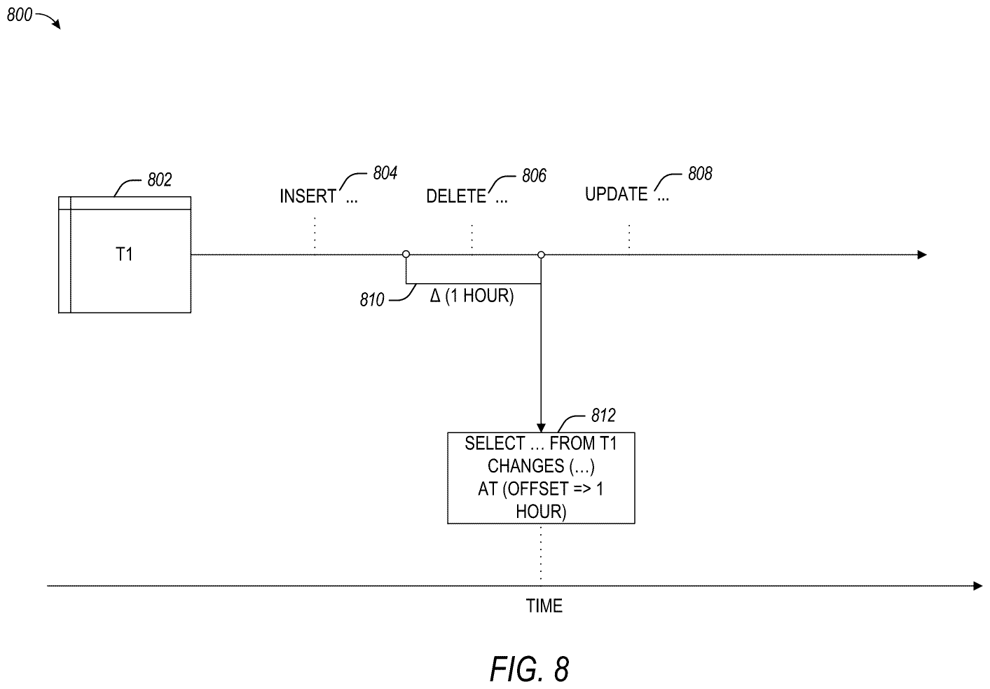

In some aspects, a stream on a DT can be created, similarly to a stream on a view (which is discussed in connection with FIG. 8-FIG. 12).

FIG. 4 is diagram 400 illustrating an example data enrichment pipeline using DTs, in accordance with some embodiments of the present disclosure.

In some aspects, DT definitions are rendered into a dependency graph, where each node in the graph is a DT query, edges indicate that one DT depends on the results of another, leaf nodes are DTs on base tables, and DDLs (e.g., DDL commands) can be used to log graph changes to a metadata database (e.g., metadata database 112), and an in-memory representation of the graph can be rendered.

Referring to FIG. 4, DT Enriched1 404 is created using a subset of base tables 402, namely, base tables Facts and Dim1. DT CleanDim2 406 is created using base table Dim2 of base tables 402. DT Enriched2 408 is created from DTs Enriched1 and CleanDim2. In this regard, the following processing sequence can be used: (a) a DT is created using other DTs; (b) the DTs (e.g., the DTs 404-408 in FIG. 4) form an acyclic dependency graph (e.g., a directed acyclic graph or DAG); a query in the final DT (e.g., DT Enriched2 408) is parsed to obtain two or more dependent DTs (e.g., DTs Enriched1 404 and CleanDim2 406); and DT refreshes can be scheduled based on the configurations of each DT.

In some aspects, DT refreshes can be scheduled at aligned time instances (or ticks) for consistency. In some aspects, DTs can be joined at consistent times without fine-grained refreshes. A user can provide a lag duration (or lag) target, and refreshes can be scheduled to meet that target. For example, a set of canonical refresh times (e.g., ticks) is selected, which align refreshes at different frequencies. In some aspects, the ticks can be determined based on the following equation: ticks={UnixEpoch+48 seconds*2^{f}*n}, where f is the frequency level, and n is the refresh instance. In some aspects, refreshes can be scheduled at the nearest tick that meets the user's lag target. Common examples of lag targets and tick periods are provided in Table 1 below:

TABLE 1

| | | | | | | | | | | |
|---|---|---|---|---|---|---|---|---|---|---|
| Target | 1 | min | 5 | min | 15 | min | 1 | hr | 25 | hr |
| Lag | | | | | | | | | | |
| Tick | 48 | sec | 3.2 | min | 12.8 | min | 51 | min | 13.6 | hr |
| Period | | | | | | | | | | |

Using the above techniques can yield alignment at two scopes: account-wide (DTs can be joined with snapshot isolation) and deployment-wide (DTs can be joined with read-committed isolation).

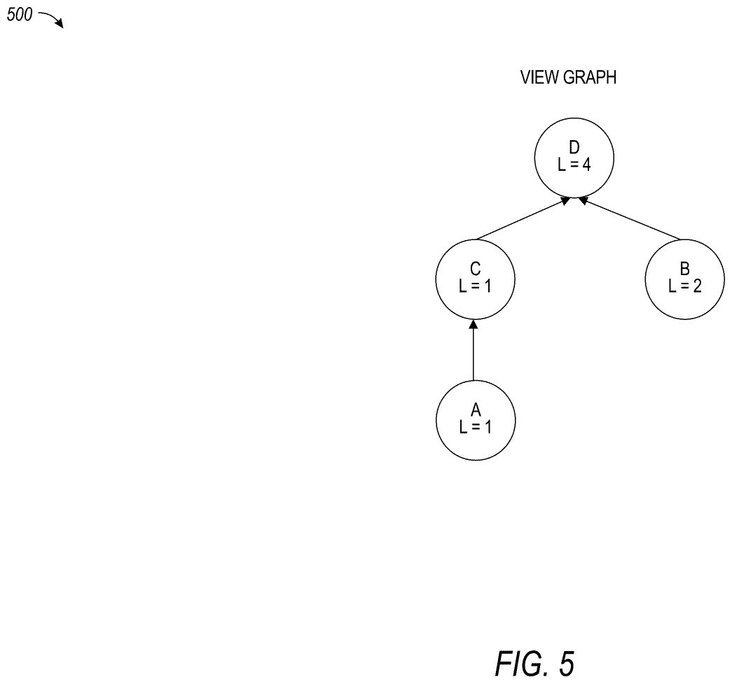

FIG. 5 is a diagram of a view graph 500 of DTs associated with different lag targets, in accordance with some embodiments of the present disclosure. Referring to FIG. 5, graph 500 is associated with a dependency relationship between DTs with different lag durations (indicated as L). For example, DT A (with lag duration L=1) feeds to DT C (with L=1). DT D (with L=4) uses data from DT C (L=1) and DT B (L=2).

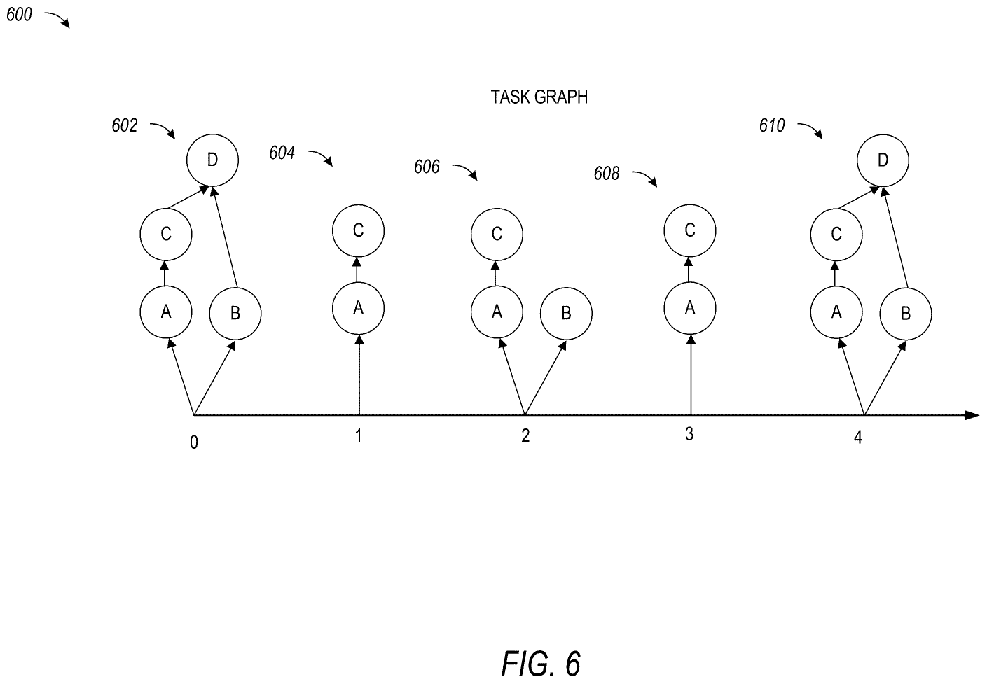

FIG. 6 is a diagram of a task graph 600 of DTs associated with scheduled refreshes at different times according to individual lag targets, in accordance with some embodiments of the present disclosure. Referring to FIG. 6, graph 600 shows scheduled refreshes of DT groups 602, 604, 606, 608, and 610 at corresponding ticks 0, 1, 2, 3, and 4. More specifically, graph 600 shows scheduled refreshes of the DTs of FIG. 5 based on their lag durations. At time instances 0 and 4 (or ticks 0 and 4), all DTs (A, B, C, and D) are refreshed. At ticks 1 and 3, DTs A and C are refreshed, and at tick 2, DTs A-C are refreshed.

As illustrated in FIG. 6, DTs can be refreshed with different refresh cadences based on the corresponding DT lag durations. In some aspects, the refresh cadences can be configured so that when the DTs are refreshed, the DTs always produce results that their corresponding queries would have produced at some point in time.

In some aspects, a refresh can be configured to execute a maintenance plan that updates the DT's physical table. In some aspects, at each tick, a rooted prefix of the DAG (e.g., the DT dependency graph) can be refreshed. A consistent snapshot of the DAG can be maintained in memory, and a compute service task can be scheduled for each connected component. The connected component task can enter a scheduling loop, which finds nodes with satisfied dependencies and starts a refresh job. In some aspects, a refresh job has a maintenance plan, which can take one of the following forms: (1) a full refresh (truncate the DT table and insert the result of running the DT definition at the tick time); and (2) incremental refresh (compute the changes in the DT since the last refresh tick and merge them into the DT table).

In some aspects, the refresh job creates table versions at the tick time. New DT table versions can be configured with a new property containing the base tables' version IDs. Retries can skip re-computation if the version has already been computed. Additionally, queries can resolve the correct version by specifying an entity version AT(DT_BASE_TIME=><ts>).

The following maintenance plan configurations can be used with the disclosed DT-related functions. The disclosed configurations can be used for the maintenance of DTs via full refreshes and incremental updates. The disclosed design configuration can be used to ensure that DT updates preserve the DT history, which can be essential for time-travel queries to produce consistent results and for computing the updates of downstream views.

In some aspects, DTs can be maintained in the following two ways:
(a) Incremental Update. For an update tick, the set of delta changes (delta set) since the last update is computed and merged into the DT. This technique can use the following configurations: (1) all operations of the DT definition are supported for incremental maintenance, and (2) all base relations provide access to their history and can provide their delta sets.
(b) Full Refresh. For each update tick, the view definition is recomputed, and the DT is fully replaced. This technique can be used if the DT definition includes operations that are not yet supported for incremental updates or if it is not possible (or feasible) to retrieve the delta set of a based relation.

In some aspects, incremental updates and full refreshes can be dynamically switched from one to the other (e.g., based on a detected data processing latency characteristic or other configuration settings).

In some embodiments, all rows in a DT can be uniquely identifiable by a ROW_ID metadata attribute. The ROW_ID attribute can be used to match changes from the delta set with the rows in the DT or compute delta sets from a DT that is fully refreshed (e.g., depending on the size of the DT, this can be beneficial because it allows for incremental maintenance of downstream views). Hence, each DT can have a ROW_ID metadata column (which corresponds to the metadata columns of tables with enabled change tracking).

Example requirements for the ROW_ID include incremental and at-once computation of the ROW_ID that may yield the same value, and collisions of ROW_IDs may result in data corruption. In some aspects, unique mechanisms may be used if base relations are referenced multiple times (self-join, self-union-all, . . . ). Generation can be insensitive to plan changes (join order, input order, . . . ). In some aspects, runtime validation ROW_IDs can be expensive for production, but a debug mode can be added for tests (e.g., full column comparisons for DELETE and UPDATE changes and uniqueness check for INSERT changes can be performed). In some aspects, streams on views can be used to address the ROW_ID requirements.

In some aspects, the following configurations may be used for incremental update maintenance of DTs. Given a delta set (e.g., a set of changes applied to a DT such as an Insert, a Delete, or an Update) for a DT, it can be applied to the DT in two ways:
(a) Single MERGE command. All changes (e.g., encompassed by the delta set) are applied with a single MERGE DML. Updates are processed as upserts (or merges) on the ROW_ID merge key. The following pseudo-code in Table 2 can be used for performing the MERGE command.

```
TABLE 2
MERGE INTO dt m
USING (
  SELECT *, metadata$action, metadata$isupdate, metadata$row_id
  FROM delta_set
  WHERE
    -- upsert on ROW_ID doesn't require the DELETE of an UPDATE change
    NOT (metadata$action = ‘DELETE’ AND metadata$isupdate = TRUE)) AS d
ON m.metadata$row_id = d.metadata$row_id
WHEN MATCHED AND metadata$action = ‘DELETE’
  THEN DELETE
WHEN MATCHED AND metadata$action = ‘INSERT’ AND metadata$isupdate
= TRUE
  THEN UPDATE SET m.* = d.*, m.metadata$row_id = d.metadata$row_id
WHEN NOT MATCHED AND metadata$action = ‘INSERT’ AND
metadata$isupdate = FALSE
  THEN INSERT (*, m.metadata$row_id) VALUES (d.*, d.metadata$row_id);
```

(b) A MERGE command followed by an INSERT command. The DELETE and UPDATE changes of the delta set can be applied with a MERGE DML command. The INSERT changes can be applied later with a separate INSERT DML command. The following pseudo-code in Table 3 can be used for performing the MERGE command followed by the INSERT command.

```
TABLE 3
MERGE INTO dt m
USING (
  SELECT *, metadata$action, metadata$isupdate, metadata$row_id
  FROM delta_set
  WHERE
    -- upsert on ROW_ID doesn't require the DELETE of an UPDATE change
    NOT (metadata$action = ‘DELETE’ AND metadata$isupdate = TRUE)
    -- INSERT changes are applied with subsequent INSERT DML
    AND NOT (metadata$action = ‘INSERT’ AND metadata$isupdate = FALSE)
AS d
ON m.metadata$row_id = d.metadata$row_id
WHEN MATCHED AND metadata$action = ‘DELETE’
  THEN DELETE
WHEN MATCHED AND metadata$action = ‘INSERT’ AND metadata$isupdate
= TRUE
  THEN UPDATE SET m.* = d.*, m.metadata$row_id = d.metadata$row_id;
INSERT INTO dt(*)
SELECT d.*
FROM delta_set d
WHERE metadata$action = ‘INSERT’ AND metadata$isupdate = FALSE;
```

The above processing can reduce the amount of data to match during a MERGE. The delta set may be persisted to consume from both DMLs.

In some aspects, using ROW_ID as a merge key may create a performance issue (e.g., artificial join keys have a wrong locality and can result in inferior performance; an additional merge key may need to be added).

In some aspects, the MERGE, as configured by both approaches, may require a perfect delta set without duplicate keys. However, deduplicating changes to obtain a perfect delta set can be costly. Streams can produce perfect delta sets, and no deduplication is needed. Bitsets may reduce the cost to derive delta sets with duplicates significantly such that they outperform perfect delta sets. In some aspects, the MERGE can be configured to deduplicate merge keys. In some aspects, the delta streams can be used to address redundancies (e.g., an insert and delete with the same row ID and the same values for all columns). More specifically, delta streams can filter out redundancies, and bitsets can reduce the number of such redundancies substantially.

In some aspects, the following configurations may be used for full refresh maintenance. A full refresh set can be computed by evaluating the view definition (enriched by the computation of the ROW_ID attribute) on a consistent version of all base relations. The refresh set can be applied in two ways:
(1) Full replacement: deletes all rows of the DT and inserts all rows of the refresh set. Commands listed in Table 4 can be used for a full replacement.

TABLE 4

DELETE FROM dt;
INSERT INTO dt(*)
SELECT f.*
FROM full_set f;

In some aspects, the ROW_ID ensures that a delta set can be computed from the fully refreshed DT. Depending on the DT size, this processing may be expensive because a full scan and processing of both versions of the DT may be needed.
(2) Merging Changes: compute the differences between both DT versions and evolve the DT into the new version. First, delete all rows that are no longer in the new version, then update all rows that were modified and insert all new rows with a MERGE DML. Commands listed in Table 5 can be used for merging changes.

```
TABLE 5
DELETE FROM dt m
WHERE m.metadata$row_id NOT IN (
SELECT metadata$row_id FROM full_set);
MERGE INTO dt m
USING full_set f
ON m.metadata$row_id = f.metadata$row_id
-- update record
WHEN MATCHED AND m.* <> f.*
  THEN UPDATE SET m.* = d.*, m.metadata$row_id = d.metadata$row_id;
-- insert record
WHEN NOT MATCHED
  THEN INSERT (*, m.metadata$row_id) VALUES (d.*, d.metadata$row_id);
```

In some aspects, merging changes can be more expensive than fully replacing the DT. However, it may be cheaper to extract a delta set from a DT that was updated by merge because fewer records might have been changed. The initial approach to applying full refresh sets can be a full replacement.

In some aspects, delta sets can be persisted as temporary tables. This allows for merging the delta set in multiple steps (e.g., MERGE for UPDATE/DELETE and INSERT), computing and persisting the delta set before the previous delta has been applied on the DT (e.g., defer merging until DT is on the right version), and scan delta set from the persisted table instead of computing it from DT's history when updating downstream DTs.

After the delta set is merged to its DT and all downstream DTs are updated, the temporary table can be deleted.

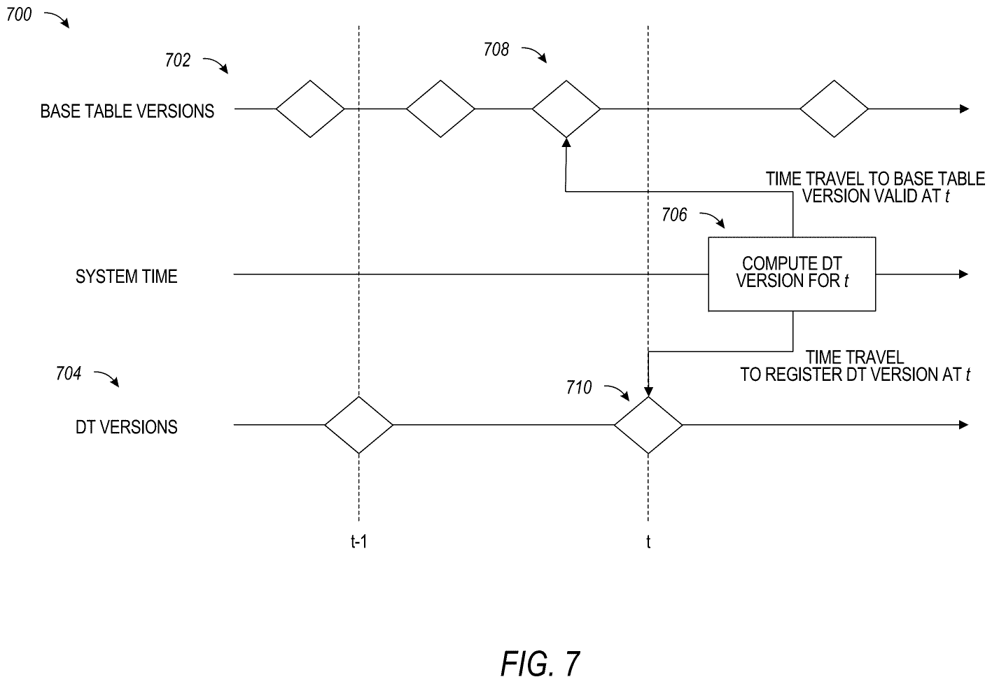

FIG. 7 is diagram 700 illustrating the use of DML commands and time travel queries to compute an updated set of a DT with respect to specific versions of its base relations, in accordance with some embodiments of the present disclosure.

In some aspects, the table versions 704 of DTs may be aligned with the base table versions 702 of their corresponding base tables. Using time travel queries (e.g., query 706), the update set of a DT 710 may be computed concerning specific versions (e.g., base table 708) of its base relations (e.g., as illustrated in FIG. 7). The new DT version that results from merging the update set in alignment may be registered with the versions of its base relations. Hence, capabilities for the DMLs that update DTs may also be configured. The following describes how to register table versions for DTs and how to look up their versions when they are queried for a specific time.

In some aspects, DML commands that create table versions at a specific time in a DT's base tables' time domain can be configured. The base version time of a new version can be assumed to be after all preceding DT table version base times. Additionally, reads can resolve table versions in this time domain.

In some aspects, streams on DTs can be configured similarly to streams on views (e.g., as discussed in connection with FIGS. 8-12).

FIG. 8 is a diagram 800 of using a CHANGES clause in connection with query processing, in accordance with some embodiments of the present disclosure. Referring to FIG. 8, queries or data processing commands Insert 804, Delete 806, and Update 808 are applied to source table 802. As illustrated in FIG. 8, the SELECT statement 812 may be used to return the changes that occurred to the source table 802 during period 810 (e.g., one hour).

As used herein, the term “stream” refers to a table and a timestamp. In some aspects, a stream may be used to iterate over changes to a table. When a stream is read inside a DML statement, its timestamp may be transactionally advanced to the greater timestamp of its time interval.

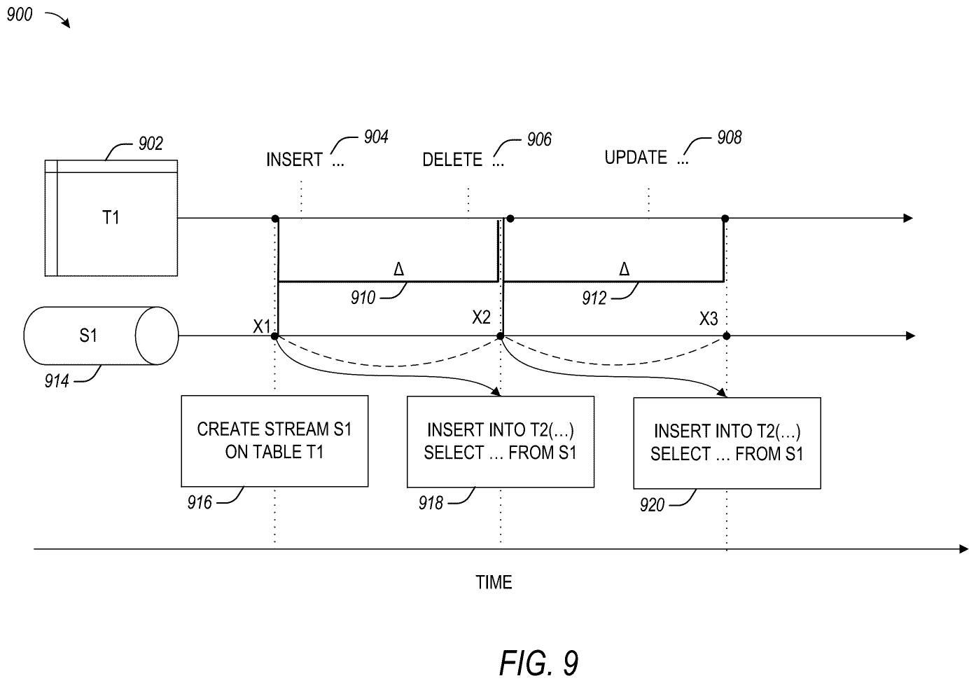

FIG. 9 is diagram 900 of a stream object configuration for a table, in accordance with some embodiments of the present disclosure. Referring to FIG. 9, queries or data processing commands Insert 904, Delete 906, and Update 908 are applied to source table 902. As illustrated in FIG. 9, a stream 914 is generated on source table T1 902 at times X1, X2 (after a time interval of 910 from X1), and X3 (after a time interval of 912 from X2). Additionally, at operation 916, stream S1 is created on table T1. At operation 918, stream S1 produces the changes in T1 from time X1 to time X2, which are inserted into table T2. At operation 920, stream S1 produces the changes in T1 from time X2 to time X3, which are inserted into table T2.

As used herein, the term “access control” indicates that customers can control who can access database objects within their organization.

As used herein, the term “data sharing” indicates that customers can grant access to database objects to other organizations.

In some aspects, any query with a CHANGES clause or a stream may be referred to as a change query. A change query on a view may be defined similarly.

In some embodiments, the DT manager 128 is configured to provide changes to views (e.g., a stream on views) so that the changes may be further processed and acted on. More specifically, the DT manager 128 may be configured to provide or process streams on views in connection with the following three use cases: shared views, complex views, and view evolution. In some aspects, more than one use case may apply at a given time.

Shared (secure) views may be used to provide (e.g., a user or organization) limited access to sensitive data. The consumer of the data often wishes to observe changes to the data being shared with them. Some considerations implied by this use case include giving the consumer visibility into the shared view's retention period and how to enforce secure view limitations on change queries.

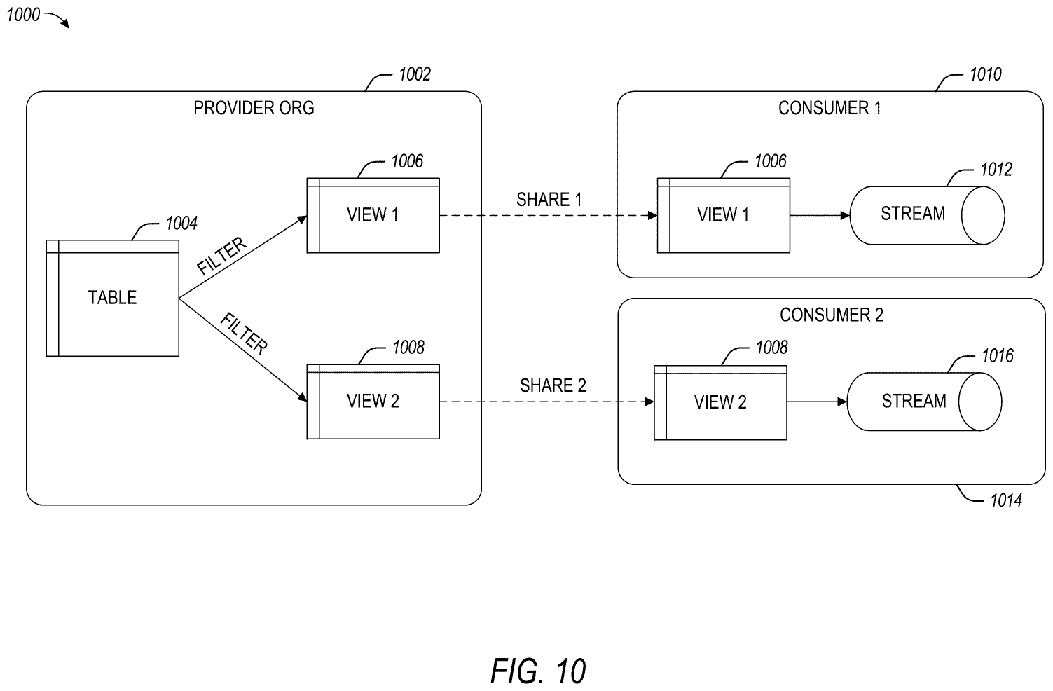

FIG. 10 is a diagram 1000 of shared views, in accordance with some embodiments of the present disclosure. Referring to FIG. 10, a data provider 1002 manages a source table 1004. The data provider 1002 applies different filters to source table 1004 to generate views 1006 and 1008. View 1006 is shared with consumer 1010, and view 1008 is shared with consumer 1014. In some embodiments, the DT manager 128 is used for configuring streams 1012 and 1016 on corresponding views 1006 and 1008 for consumption by consumers 1010 and 1014.

The definition of a view can be complex, but observing the changes to such a view may be helpful regardless of its complexity. Manually constructing a query to compute those changes may be achieved, but it can be laborious, error-prone, and suffer from performance issues. In some aspects, a change query on a view may automatically rewrite the view query, relieving users of this burden. In some aspects, simple views containing only row-wise operators (e.g., select, project, union all) may be used. In some aspects, complex views that join fact tables with (potentially several) slowly changing dimension (DIM) tables may also be used. Other kinds of operators like aggregates, windowing functions, and recursion may also be used in connection with complex views.

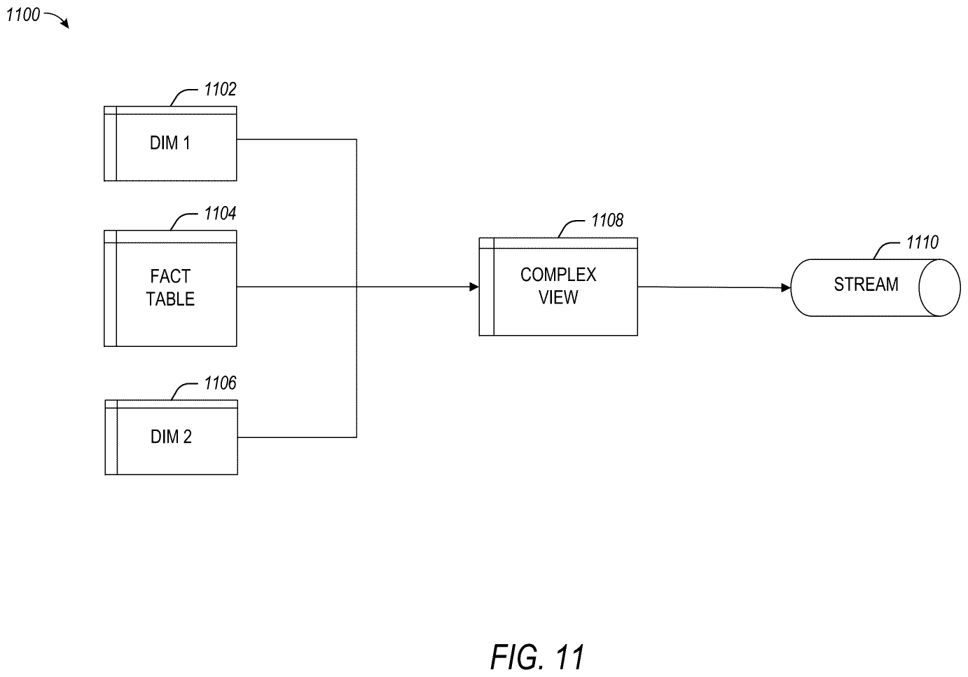

FIG. 11 is diagram 1100 of a stream object based on a complex view, in accordance with some embodiments of the present disclosure. Referring to FIG. 11, a complex view 1108 may be generated based on source tables 1102, 1104, and 1106. In some embodiments, the DT manager 128 configures a stream 1110 based on the complex view 1108 of source tables 1102, 1104, and 1106.

In some aspects, views may be used to create an abstraction boundary, where the underlying tables can be modified without consumers being aware. For example, a view over a table undergoing a backward-incompatible schema change may be replaced by a new query that presents the same data in a different query, causing a view evolution. In some aspects, change queries may work across view redefinition, allowing change observation to the view uninterrupted by modifications to its definition. Considerations for this use case may include schema compatibility and performance. Some view redefinitions may use full joins to resolve, and others, such as workflows involving table clones, could be resolved more efficiently.

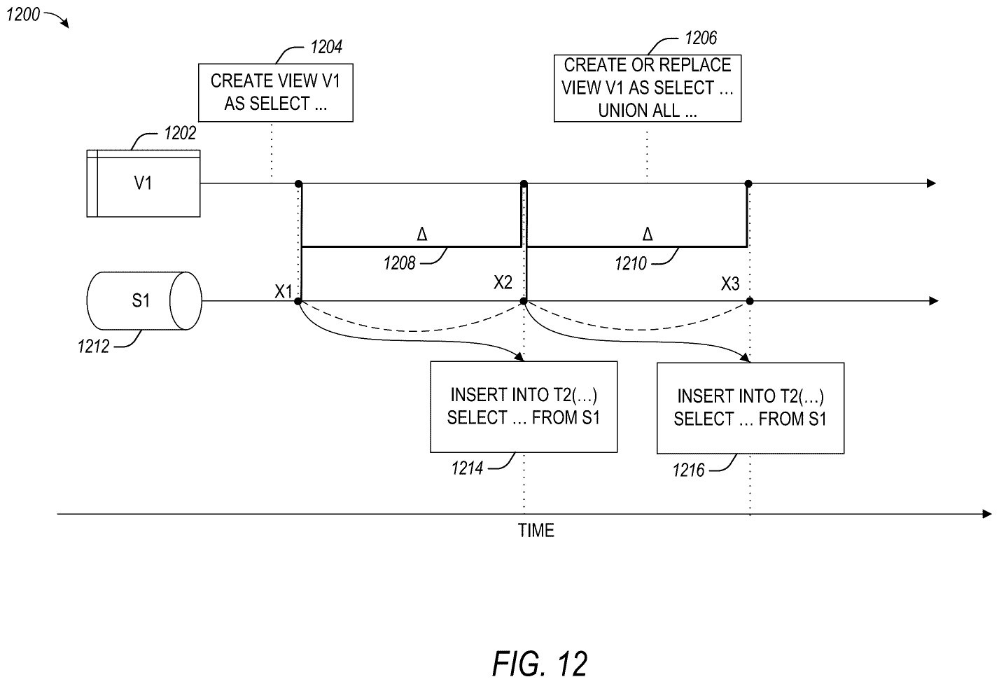

FIG. 12 is diagram 1200 of a view evolution, in accordance with some embodiments of the present disclosure. Referring to FIG. 12, at operation 1204, view V1 1202 is created based on a Select operation. Stream S1 1212 of view V1 1202 is generated at times X1, X2 (after a time interval of 1208 from X1), and X3 (after a time interval of 1210 from X2). Additionally, at operation 1214, a stream entry from stream S1 at time X2 is inserted into table T2. Before time X3, view V1 1202 evolves at operation 1206 when a union all operation is used. At operation 1216, a stream entry from stream S1 (based on the evolved view V1 at time X3) is inserted into table T2.

In some embodiments, to provide or process streams on views in connection with the above-listed use cases, the DT manager 128 may be configured with the following functionalities: intuitive semantics, unsurprising security, linear cost scaling, and easy operability.

In some aspects associated with intuitive semantics, change queries on views may work intuitively and consistently. The essence of a change query is to take a time-varying object and a time interval, then return a set of changes that explain the differences in the object over the interval. This definition applies naturally to views, but some additional configurations are addressed below.

As not all operations may be supported by the DT manager 128, property on views may be configured to allow change queries on it explicitly: CHANGE_TRACKING=true. When a view is created with this property enabled, a validation is performed that it only contains supported operators, and the base tables have change tracking enabled. When a change query is issued on a view, it may succeed if the view has change tracking enabled.

In some aspects, a standing change query (e.g., a stream) may exhibit reference semantics. That is, when a user specifies a view in a change query, such specification may be interpreted as referring to the view itself, not what the view is currently defined as. Adopting value semantics would likely result in surprising behavior, especially around access management.

Adopting reference semantics is associated with the ways a view can be modified. The following techniques may be used for view modifications:
(a) “ALTER VIEW . . . RENAME TO . . . ” When a view is renamed, objects referencing it may be updated. Complying with this precedent means a stream should break if its view is renamed.
(b) “ALTER VIEW . . . SET SECURE . . . ” If a view is made secure, subsequent change queries to it should enforce secure view constraints.
(c) “CREATE OR REPLACE VIEW . . . ” If a view is replaced, there are processing choices. Per the View Evolution use case, some users may want the view to keep working as long as the replacement is schema-compatible. However, this may add complexity to the implementation.

In some aspects associated with unsurprising security, a consumer of a change query on a view may have the same access they have to the view itself. The following configurations may apply to all views: creating a stream on a view fails if the underlying tables do not have change tracking enabled and the creator does not have permission to enable it; consumers can see the minimum retention period of the tables referenced by a view (they cannot see which table the retention applies to); and if change tracking was enabled on a table in a view more recently than the beginning of the retention period, consumers can see when it was enabled.

In some aspects, the following configurations may be applied to secure views: consumers cannot see the view's definition; consumers cannot issue a change query before access is granted to the view; optimizations abide by secure view limitations (they do not reorder operators into the expanded view), and the retention period on a table in a secure view is not extended automatically to prevent a consuming stream from going stale.

In some aspects associated with linear cost scaling, an essential attribute of change queries on tables is that their cost (both in terms of latency and credits) may be proportional to the result size. Append-only change queries may be introduced to work around cases when this scaling does not hold for delta queries. In some aspects, change queries on views may scale similarly in cost. That is, delta change queries and append-only change queries may scale proportionally to the result size.

In some aspects associated with easy operability, introducing change queries on views may increase the likely distance between the view provider and consumer (the shared views use case may revolve around this). The distance makes collaboration between provider and consumer more difficult. In turn, this means that a smooth operational experience for change queries on views is more critical than for traditional change queries. In some aspects, the following operational challenges may be addressed by the DT manager 128: handling view modification and surface errors.

In some aspects associated with the handling of view modifications, if the view provider renames or replaces their view, a stream on it will break. The consumer will then want to take action to repair it. The details of such repairs are use case-specific, but it may involve trying to recreate the stream with a new definition and resuming where the broken stream lets off. To support this, the DT manager 128 may be configured to support statements of the following form: CREATE OR REPLACE STREAM s . . . AT (STREAM=>s). The stream S is being both queried and replaced.

In some aspects associated with surface errors, consumers may try to issue change queries that are invalid for various reasons. The errors may be surfaced clearly to the consumer. Examples of such errors include: the underlying tables may not have change tracking enabled; the change query may be outside of the tables' retention period; the change query may contain unsupported operators; and the view may have been modified, breaking the change query.

View providers may have control over what happens to a view and any objects derived from it. However, they would benefit from visibility into how the view is being used to avoid accidentally breaking consumers. Examples of such notices include when the provider tries to make a breaking modification to a view, warn the provider that consumers will be disrupted; when consumers' change queries fail due to retention or change tracking, send the provider a notification; and support some introspection as well, such as a view provider looking up the number of streams consuming it and their offsets.

A stream object on tables (including external tables) may be configured to let the user retrieve a stream of changesets as the underlying data in the table changes. A stream object is configured to maintain a position in this list of changesets, and that position is only advanced if it is used in a DML statement. Reading from the stream may return the changeset from the current position up to the current transaction timestamp. As the underlying data changes, the size of the changeset will grow until the stream is advanced. In some aspects, the advance may be transactional.

In some embodiments, the DT manager 128 is configured to create and process stream objects on views, in particular for data-sharing scenarios. In some aspects, shared data consumers may be able to get the latest changes from the shared data provider. Given that exposing shared data is done through secure views, a stream may be created on the consumer side on the view from the provider. In some aspects, streams on materialized views may also be configured to allow retrieving changesets as the underlying MV changes.

In some embodiments, providing changesets on a view (e.g., a query) is similar to the incremental materialized view maintenance problem. In the case of MVs, as the underlying data source(s) change, the materialized data set may be updated incrementally. In some aspects, this processing may be performed at the micro-partition level to create a query plan that uses the data from the added/deleted partitions and merges it with the MV data to produce the updated data.

In the case of a stream object (or stream) on a view, the changeset returned may be the delta of the data the view would return at the current transactional time compared to the data the view would return at the transactional time of the position of the stream. In some aspects, computing the delta efficiently may be a consideration since there may be no materialized data set that can be leveraged and incrementally updated. In some aspects, a materialized view may be created behind the scenes to mitigate this with the limitations of the queries MVs support today, which can make sense, especially for aggregate queries.

In some aspects, the delta for certain classes of queries may be generated efficiently (e.g., if there is only one data source). In that case, the data source of the view can be logically replaced with the delta provided by the stream on the data source. In some embodiments, the DT manager 128 may support projections and filters in the view as well. For example, data processing operators may be allowed where applying the operators on the delta provides the same result as computing the delta on the datasets at the two endpoints. In the initial solution, when the stream is created on a view, support for the view is validated, the data source table is located, and change tracking is set up for the table. When the data is requested from the stream, the underlying view in the query plan is expanded, and the data source table is replaced with generating the delta (similar to the processing applied if a stream on that table is configured in the first place). This processing may also be supported for secure views as well since the data source inside is swapped, and no outside filters would get pushed in.

In addition to maintaining the position of the start point of the change set, the stream may also implicitly expand the retention period on the underlying table up to two weeks depending on how far in the past of the table version history the stream position points. Such processing may also be performed for non-remote data sources. For shared data sources, the same mechanism may not be used because the table compaction status data on the remote side would need to be updated. In this regard, streams on shared data sources can go stale after a day, which is the default retention period for tables. To mitigate this effect, the provider of the shared data can increase the retention period on the table to allow more time for the stream on the provider side to be consumed (and advanced).

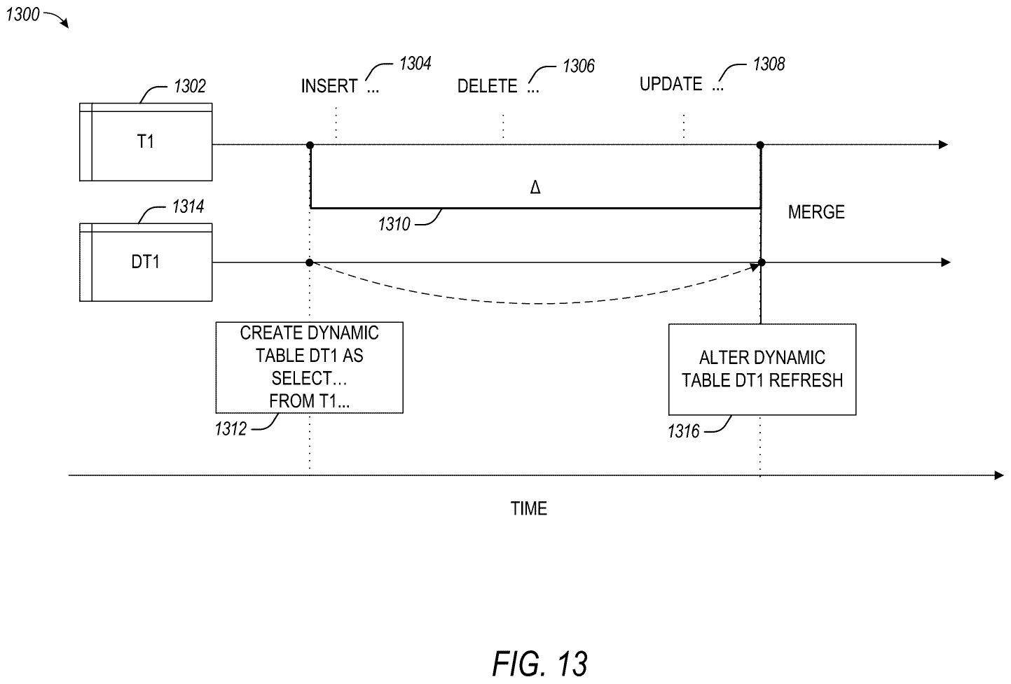

FIG. 13 is diagram 1300 of a DT refresh, in accordance with some embodiments of the present disclosure. Referring to FIG. 13, at operation 1312, a materialized table DT1 1314 is created as a select from base table T1 1302. A delta set 1310 can be computed for the base table 1302, which can include data changes based on an Insert operation 1304, a Delete operation 1306, and an Update operation 1308 applied to base table 1302. A refresh operation 1316 can be performed on DT1 1314 by merging the delta set 1310 with DT1 1314.

In some aspects, an incremental refresh of DTs can be configured using configurations and techniques discussed herein. An incremental refresh can be a more optimal function than computing the state of a DT every time a refresh is needed. During an incremental refresh, data is considered from the last time query results are computed, the difference between the query results and a new value is determined, and the determined change (or difference) is applied on top of the previous result.

The disclosed incremental refresh configurations can be used to handle several interdependent scenarios, which can make it challenging to partition into independent pieces. The scenarios are:
(a) Nested DTs: a DT queries another DT. Changes to one must be incrementally propagated to the other.
(b) Composite DTs: a single DT contains a sufficiently complex query that needs to be split into two or more DTs containing an intermediate state. A simple example of this scenario is COUNT (DISTINCT *).
(c) Query Facades: when querying a DT, the query plan may need to apply additional operations atop the intermediate state to compute the correct result. An example of this is AVG (_), which can be stored as SUM (_) and COUNT ( ) separately and then produced as the quotient.

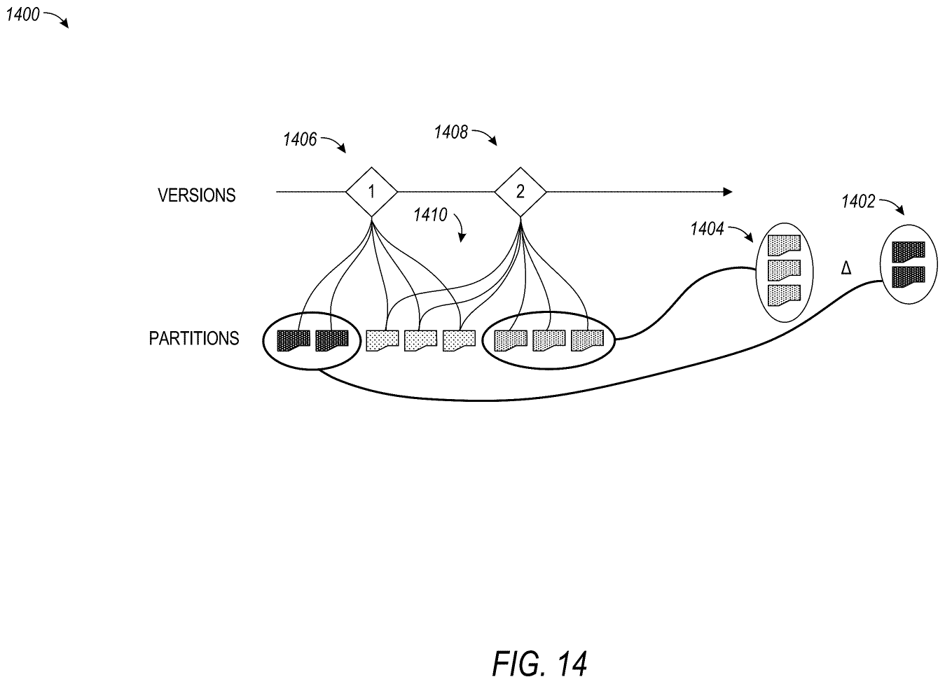

FIG. 14 is a diagram 1400 illustrating the determination of changes (or delta (Δ) or delta set) to a base table for a DT refresh, in accordance with some embodiments of the present disclosure. Referring to FIG. 14, a base table can be associated with versions 1406 and 1408 (also referenced as 1 and 2 in FIG. 14). To determine the delta set, the deleted files 1402 are determined, and the new (added) files 1404 are determined. The common files 1410 can be ignored for purposes of delta set determination. The delta set is the symmetric set difference between the rows in the deleted files 1402 and the rows in the added files 1404.

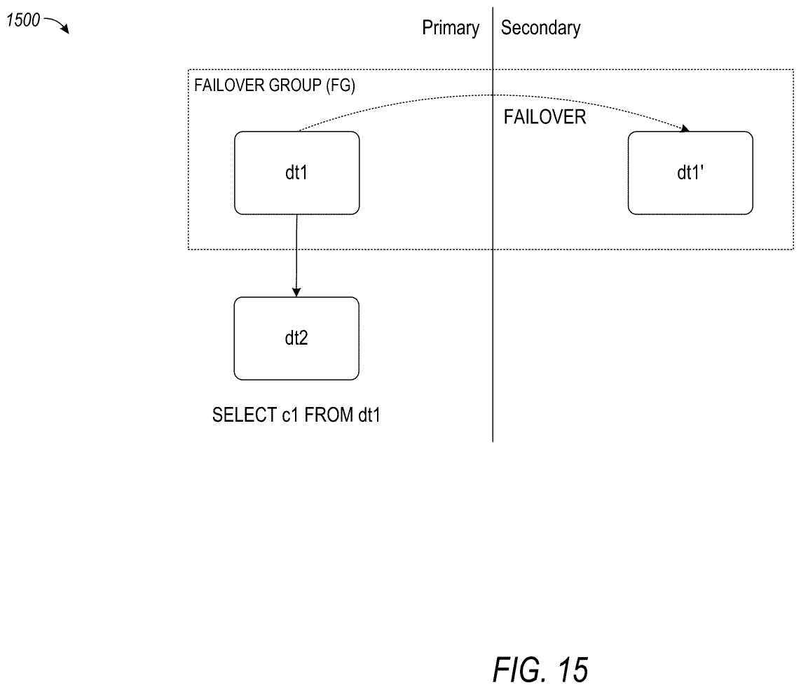

In some aspects, the DT manager 128 can configure the execution of replication operations (e.g., for disaster recovery and non-failover use cases) as discussed in connection with, e.g., FIG. 15-FIG. 25.

The disclosed DT replication techniques can be performed by the DT manager 128 and can include disaster recovery (e.g., failover), cross-region sharing, and cross-region/cross-cloud migration.

Sharing and disaster recovery both depend on replication, but they exhibit different sets of requirements, mainly around DT's ability to refresh as pipelines and cross-group replication behave.

The disclosed techniques can be used to configure the replication behaviors of dynamic tables for disaster recovery use cases. These use cases can use failover groups or database replication features.

In some aspects, DT manager 128 can configure the following DT-related functionalities:
(a) Replicate dynamic tables into secondary databases to support disaster failover. Materialized data in the primary DT incrementally land on the secondary DT in each replication refresh. Replicated dynamic tables can be configured to perform DT refresh after failover.
(b) Behaviors of dynamic tables in secondary deployments can be configured to be consistent with those in primary deployments. This includes refresh history, graph history, etc.
(c) Configure end-to-end disaster recovery for DB/FGs with DTs.

In some aspects, DT manager 128 can force a first full refresh after a failover. In some aspects, support for the first incremental refresh after failover can be prevented. In some aspects, the first refresh of DTs after failover can be configured as a full refresh that reinitializes the replicated DT. Refreshes after the initial full refresh can be incremental. In some aspects, refreshes can be disabled before failover.

In some aspects, the stream state replication, as well as the replication for content in intermediate tables, can be simplified. For example, replicating the stream state for the dynamic table can be skipped since it will be rebuilt after the full refresh. Replicating intermediate tables can also be reduced to replicating the metadata objects since the content will be populated during the full refresh.

In some aspects, DT manager 128 can configure incremental refresh of DTs. In some aspects, after a DT is replicated from a primary to a secondary site and failover to the replicated DT is initiated (e.g., based on detecting a network disaster event), a refresh of the replicated DT is initiated where the refresh picks up the replicated data in the DT and performs an incremental refresh (e.g., to bring any incremental data changes from the DT sources).

In some aspects, each time when the replication framework refreshes data from the primary to the secondary, all table versions for each table are compressed into a single table version with all partitions associated with it. To support incremental dynamic table refresh after failover, the replication framework can be configured to replicate table versions that are referenced by dynamic tables (and the associated EP files). This configuration can be similar to the configurations resolved by stream replication. Stream replication can be used for computing the minimum set of delta EP files required to compute changes between the table version referenced by any stream, and asking the replication framework to replicate these additional table versions, EP files, and partitions. The configurations for dynamic tables can be based on applying the same computation for the base tables of dynamic tables, which entails treating dynamic tables as stream targets in the replication framework.

In some aspects, a DT can consume from a replicated dynamic table. In some aspects, replicated DTs can be placed into a suspended state. This means that if there are dynamic tables that depend on replicated dynamic tables, the consumers would not be able to perform DT refreshes until a failover operation converts the replicated DT into a regular DT.

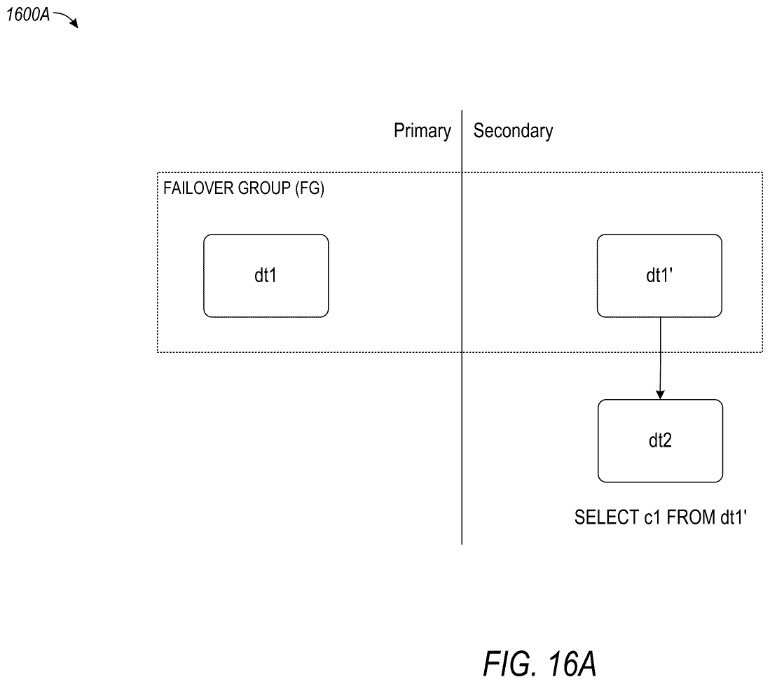

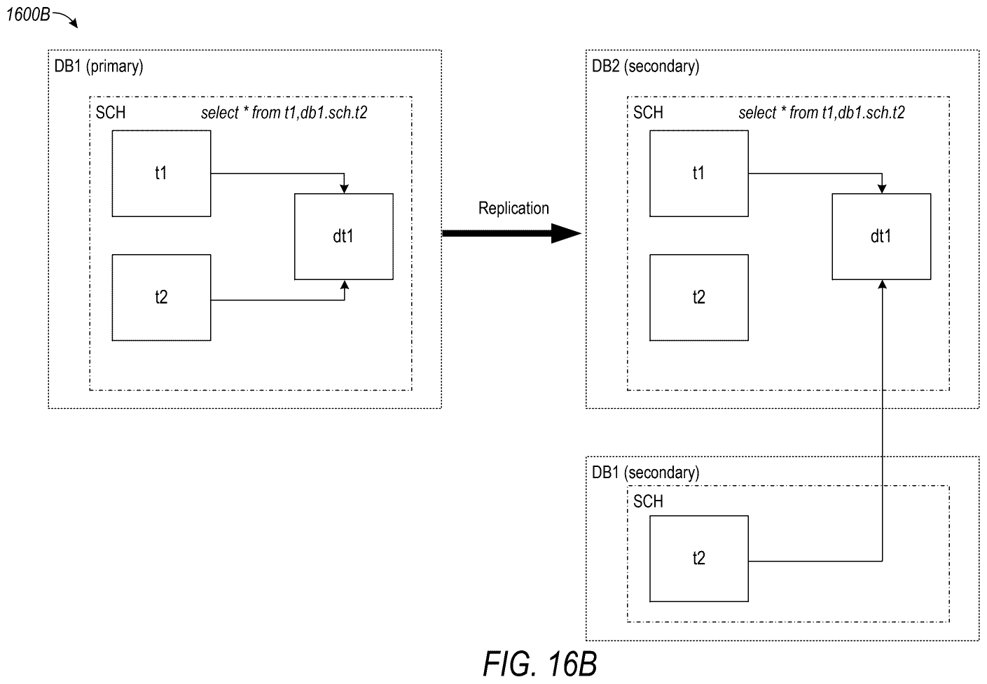

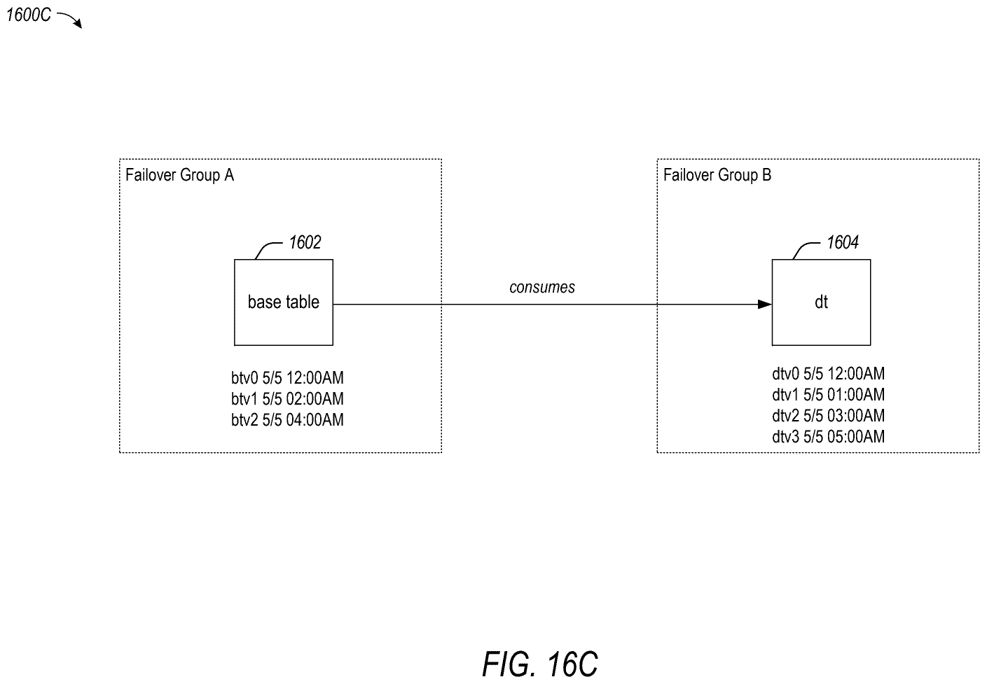

There are two ways for DTs to depend on replicated DTs, as shown in FIG. 15 and FIG. 16A. In both these cases, DTs that depend on replicated DTs do not refresh.

FIG. 15 is a diagram 1500 illustrating a configuration of a DT in a primary deployment with a dependency failing over to a DT in a secondary deployment, in accordance with some embodiments of the present disclosure. Referring to FIG. 15, DT dt1 fails over to DT dt1′, which becomes a primary DT. However, DT dt2, which depends from dt1, will not refresh after the failover since DT dt1′ is now the primary DT.

FIG. 16A is a diagram 1600A illustrating a DT that depends on a DT in a secondary deployment, in accordance with some embodiments of the present disclosure. Referring to FIG. 16A, DT dt1 is replicated as DT dt1′, with DT dt2 depending from dt1′. However, since failover has not occurred, DT dt1′ is in a suspended DT scheduling state and dt1 is still in an active DT scheduling state.

In some aspects, DT manager 128 can configure database renaming and manage DTs based on the database renaming. FIG. 16B is a diagram 1600B illustrating DT refresh in connection with database renaming, in accordance with some embodiments of the present disclosure.

In database replication, DT manager 128 can support the secondary database being renamed to a different name compared to the primary database. This can create a challenge for dynamic table refreshes after the secondary database is promoted to primary because the scheduler, which computes DAGs of connected DTs, may not perform view expansion (compiling the view text associated with a dynamic table) for each DT. Instead, the scheduler uses pre-computed “input edges” (in the form of fully qualified names of base tables) on these DTs to compute the DAGs. This pre-computed input edge metadata is essential for the scheduler's scalability.

In some aspects, when the database is renamed into a new one, objects that are referred to in the DT view text can be changed if these objects are referred to with fully qualified names that contain the old database name. Therefore, the precomputed fully qualified name input edges can become inaccurate. In the example of FIG. 16B, the database DB1 is replicated to the secondary site and renamed as DB2. Inside database DB1, a dynamic table dt1 resided in DB1 and has view text select * from t1, db1.sch.t2. According to this view text definition, dt1 depends on db1.sch.t1 and db1.sch.t2. In the secondary site, due to the database rename, the same view text definition now causes the dynamic table (now db2.sch.dt1) to depend on db2.sch.t1 and db1.sch.t2. The db1 database in the secondary site is not a result of replication but a database that was created independently.

In some aspects, the correct behavior (referring to the correct object according to the view text) can be trivially obtained by performing view expansion when scheduling dynamic tables. However, avoiding performing view expansion in the scheduler can be challenging due to scalability concerns, and instead, it can rely on pre-computed metadata to achieve the correct behavior. The solution to this issue is to augment the input edge metadata with information to remember how the input edge is referred to in the view text-whether the input edge is written as a fully qualified name or a partially-/non-qualified name in the original view text. With this information, the database name part of the input edge in the secondary can be replaced. In the above example, in the secondary, the base table t1 has an input edge spelled as db2.sch.t1, which was derived from the primary input edge (qualified_name=db1.sch.t1, has_database_name_in_view_text=false).

Referring to FIG. 16B, DT manager 128 can create DT dt1 as select * from base table t1. In the primary deployment, dt1 and t1 can be configured in the database db_primary (e.g., DB1), with t1 configured as db_primary.sch.t1. In the secondary deployment, dt1 and t1 can be configured in database db_secondary (e.g., DB2) with t1 configured as db_secondary.sch.t1.

In some aspects, DT manager 128 can create DT dt1 as select * from another_db.sch.t1. In the primary deployment, dt1 is in the database db_primary (e.g., DB1), with t1 configured as another_db.sch.t1. In the secondary deployment, dt1 is in database db_secondary (e.g., DB2) with t1 configured as another_db.sch.t1.

In some aspects, DT manager 128 can create DT dt1 as select * from db_primary.sch.t1. In the primary deployment, dt1 and t1 are in the database db_primary (e.g., DB1), with t1 configured as db_primary.sch.t1. In the secondary deployment, dt1 and t1 are in database db_secondary (e.g., DB2) with t1 configured as db_primary.sch.t1. After the replication, dt can indicate that db_primary.sch.t1 does not exist. In this case, the input edge of t1 can be changed to include the db_secondary name.

In some aspects, DT manager 128 can configure an incremental refresh when dependencies are in different FGs. FIG. 16C is a diagram 1600C illustrating an incremental DT refresh when dependencies are in different FGs, in accordance with some embodiments of the present disclosure.

In aspects when dynamic tables and their dependencies are replicated through different failover groups, DTs and tables can reside in different timelines. Consequently, joining data in the secondary breaks the snapshot consistency that is present in the primary site. Such joins across multiple timelines can produce invalid data from the user's perspective.

When the DT and its base tables are located in different failover groups, an incremental refresh may no longer work as such a solution is based on the replication framework preserving additional table versions that are referenced by streams/DTs. When only base tables but not the DT is present in the FG, the needed information may be unavailable (e.g., which base table versions are required) to compute the extra table versions.

In some aspects, it can be assumed that users have already accepted the side effect of losing snapshot consistency when they choose to replicate objects in different failover groups. In some aspects, a solution is to perform incremental refresh by allowing the DT to “rewind” to a previous table version (most recent resolvable table version, MRRTV) of which the corresponding base table versions can be found, and use that MRRTV as the starting table version of the incremental refresh.

In the example of FIG. 16C, dynamic table dt 1604 consumes from the base table 1602, and they are replicated through independent failover groups A and B. Base table 1602 has 3 table versions that are replicated (e.g., versions btv0-btv2). The timestamp after each table version represents the MT_VERSION of the table version. Dynamic table dt 1604 has 4 table versions that are replicated (e.g., versions dtv0-dtv3). If the user promotes this site to primary and starts a DT refresh at 5/5 7 AM, the DT refresh, in this case, would discard table version dtv1-dtv3, whose corresponding table versions cannot be found from table versions of the base table 1602. Version dtv0, on the other hand, can resolve the corresponding base table version btv0, both having MT_VERSION=12:00 AM. The incremental refresh then truncates the dt 1604 to dtv0, and starts a new incremental refresh with (start=btv0, end=btv2). If not, a single resolvable table version can be found on the dt, and the dt will truncate all its table versions and start a refresh at 0, which is equivalent to a reinitialization.

In some aspects, DT manager 128 can configure one or more of the following options associated with DT state transitions with a failover group. As used herein, the term “DT scheduling state” (also referred to as DT state or scheduling state) is one of active or suspended state for a DT. As used herein, the term “DT replication state” (also referred to as replication state) is one of a replica DT or a primary DT (e.g., indicating whether a DT is still a replica or a primary DT, such as when a replica DT has been failed over to and has become a primary DT after the failover).

In one aspect (e.g., Option A), the DT manager 128 can add a masking field (e.g., to DT metadata) for the DT state (DynamicTableState).

In this option, a new field is used to store the desired behavior of a DT, which can be referred to as DynamicTableReplicationState (or replication state). DynamicTableReplicationState has priority over the existing DynamicTableState (e.g., scheduling state) when it is set. The combined effect of DynamicTableReplicationState and DynamicTableState determines how the scheduler computes refresh pipelines. This, in turn, would dictate how the DT in question behaves in a refresh scheduler.

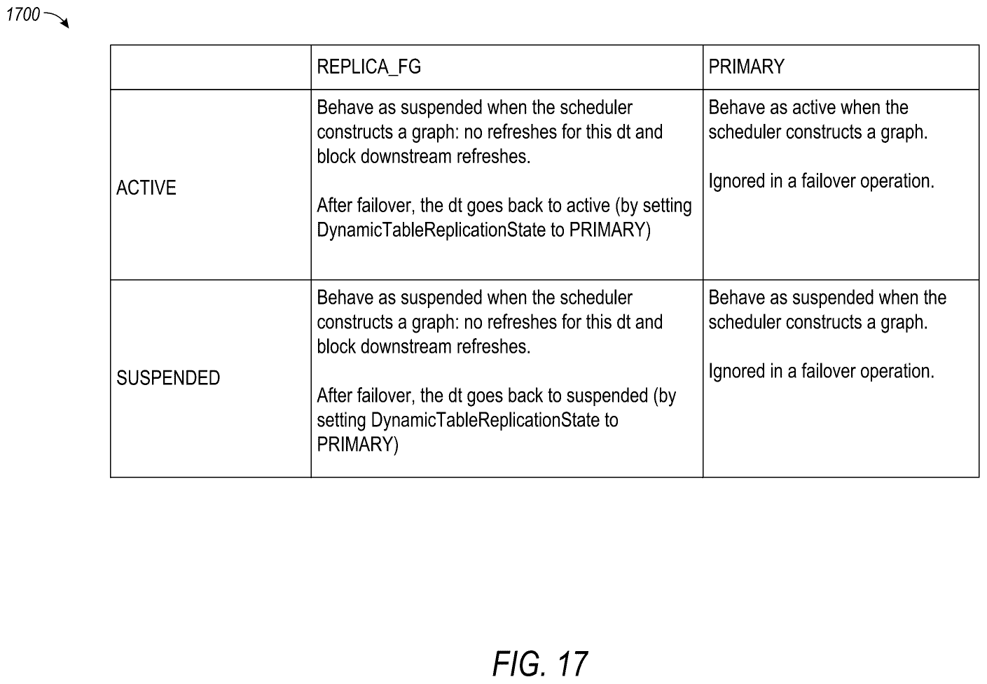

FIG. 17 illustrates table 1700 with DT replication states and DT scheduling states, in accordance with some embodiments of the present disclosure. In some aspects, when a primary DT is replicated to generate a replica DT, the replica can take the scheduling status of the primary DT. However, the scheduling status together with the DT replication state can determine the table behavior (e.g., as explained below and illustrated by table 1700, a replica DT with an active scheduling state behaves as suspended until a failover, causing the replica DT to become a primary DT, at which point it starts to behave as active)

Referring to FIG. 17, when replication state replica DT is associated with an active scheduling state, the DT behaves as suspended when the scheduler constructs a graph (e.g., no refreshes for this DT and downstream refreshes are blocked). After failover, the DT goes back to the active scheduling state (e.g., by setting DynamicTableReplicationState to PRIMARY).

When the replication state primary DT is associated with an active scheduling state, the DT behaves as active when the scheduler constructs a graph. This DT is ignored in a failover operation.

When the replication state replica DT is associated with a suspended scheduling state, the DT behaves as suspended when the scheduler constructs a graph (e.g., no refreshes for this DT, and downstream refreshes are blocked). After a failover, the DT goes back to the suspended scheduling state (e.g., by setting DynamicTableReplicationState to PRIMARY).

When the replication state primary DT is associated with a suspended scheduling state, the DT behaves as suspended when the scheduler constructs a graph. This DT is ignored in a failover operation.

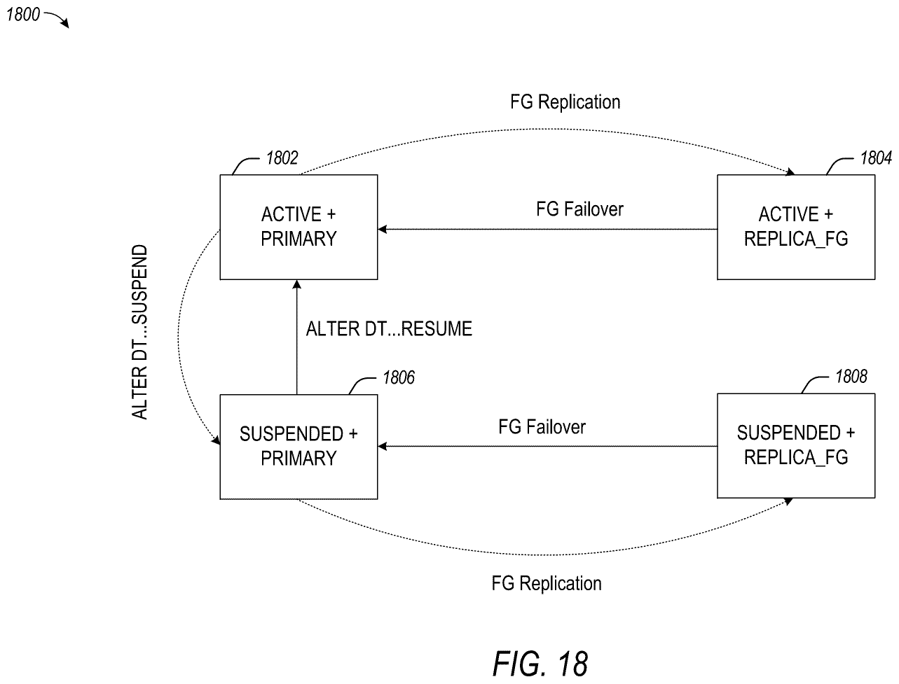

FIG. 18 is a diagram 1800 of state transitions for a primary DT and a replica DT based on the states of FIG. 17, in accordance with some embodiments of the present disclosure. Referring to FIG. 18, state 1804 is based on a replication state replica DT and an active scheduling state. Under state 1804, the DT behaves as suspended when the scheduler constructs a graph (e.g., no refreshes for this DT, and downstream refreshes are blocked). After failover, the DT goes back to the active scheduling state, such as state 1802 (e.g., by setting DynamicTableReplicationState to PRIMARY).

Under state 1802, the replication state primary DT is associated with an active scheduling state. Under state 1802, the DT behaves as active when the scheduler constructs a graph. This DT is ignored in a failover operation.

Under state 1808, the replication state replica DT is associated with a suspended scheduling state. The DT then behaves as suspended when the scheduler constructs a graph (e.g., no refreshes for this DT, and downstream refreshes are blocked). After a failover, the DT goes back to the suspended scheduling state, such as state 1806 (e.g., by setting DynamicTableReplicationState to PRIMARY).

Under state 1806, the replication state primary DT is associated with a suspended scheduling state. The DT then behaves as suspended when the scheduler constructs a graph. This DT is ignored in a failover operation.

In some aspects (e.g., Option B), the DT manager 128 can add a new field to remember prior DynamicTableState. Under this option, a new field is added to remember the state of the primary DT. In replication, the DynamicTableState of the replicated DT can be set to SUSPENDED. In the new field, the state of the source DT in the primary can be remembered. With failover operation, a synchronous override of the dynamicTableState of the replicated DT with the remembered state persisted in the field can be performed.

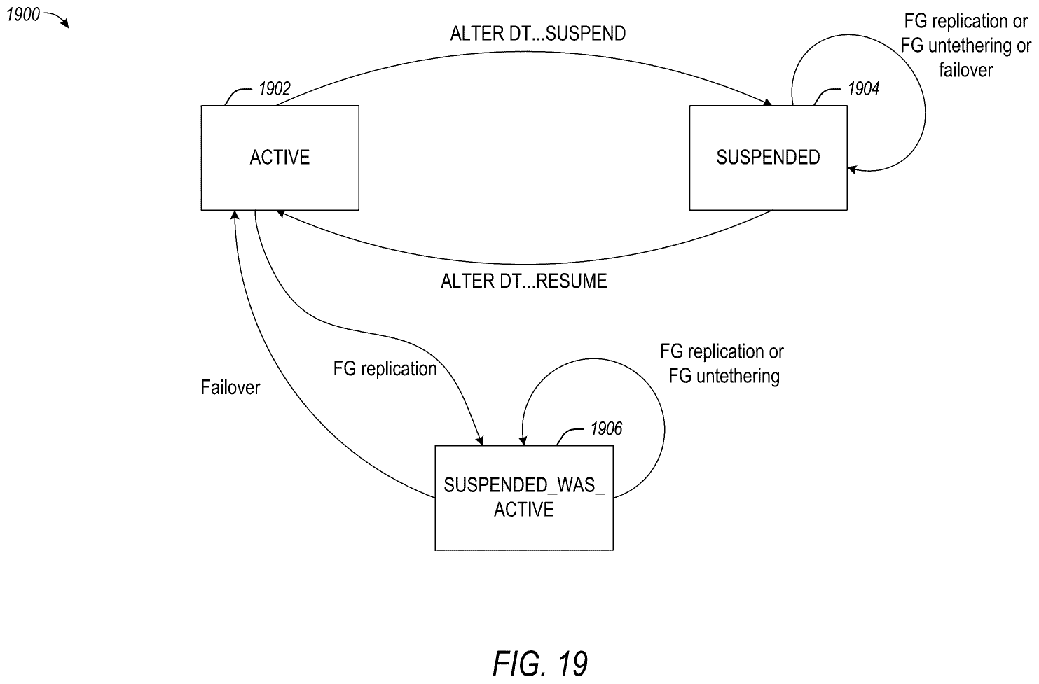

FIG. 19 is a state diagram 1900 of state transitions for a primary DT and a replica DT with added new states, in accordance with some embodiments of the present disclosure. The state diagram 1900 shows how failover replication adds new states and transitions to existing DT states.

In some aspects, (e.g., Option C as illustrated in FIG. 19), the DT manager 128 can add new states to DynamicTableState. To support reverting state in a failover operation, a new state SUSPENDED_WAS_ACTIVE state 1906 indicates that the DT is in a suspended state because of FG replication and a failover operation can change the DT state to the active state 1902. A SUSPEND operation transitions the DT from the ACTIVE state 1902 to a SUSPENDED state 1904. A RESUME operation transitions the DT from the SUSPENDED state 1904 back to the ACTIVE state 1902.

In some aspects, Option A can be considered a main option since bits can be mutated for each dynamic table in the account after a failover operation, which is valid for all three options. With Option A, the mutation would be to change DynamicTableReplicationState from REPLICA_FG to PRIMARY. With options B and C, the mutation would be to change Dynamic TableState from one state to another. Since this is a per-DT state, the state for each replicated DT in a single metadata transaction can be left unmutated. Then, there can be race conditions between the failover operation changing the DynamicTableState versus the user changing the DynamicTableState (by ALTER DT SUSPEND, for example). With option A, a failover operation changes the DynamicTableReplicationState in separate database transactions, and that is a safe operation even if the user is mutating DynamicTableState at the same time.

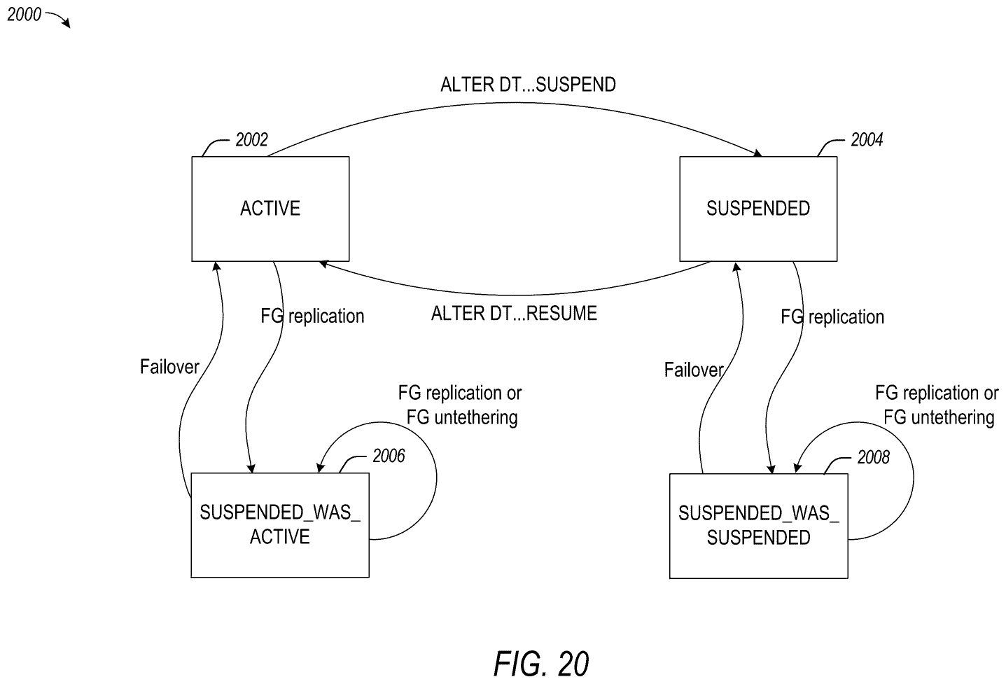

FIG. 20 is a state diagram 2000 of state transitions for a primary DT and a replica DT with added new states, in accordance with some embodiments of the present disclosure. State diagram 2000 is an alternative state diagram (e.g., option D), which includes an ACTIVE state 2002, a SUSPENDED state 2004, a SUSPENDED_WAS_ACTIVE state 2006, and a SUSPENDED_WAS_SUSPENDED state 2008.

In some aspects, an alternative to the state graph of FIG. 19 is to give DTs suspended in an FG their dedicated state, similar to the SUSPENDED_WAS_ACTIVE state. State diagram 2000 is a less compressed state transition graph, but it can be easier to parse and diagnose issues.

In some aspects, DT manager 128 can provide support for cross-group DT pipeline replication that maintains snapshot consistency among objects. If a DT pipeline spans more than one replication group, maintaining the snapshot consistency in the secondary deployment can be challenging, even if all parts of the pipeline are replicated (if they were replicated through different replication groups, they may not share the same snapshot).

In some aspects, replication can fail for a replication group that contains a DT that depends on tables (DT or not) that are not in the same replication group. This behavior is consistent with the one chosen by stream replication.

In some aspects, DT manager 128 can configure dynamic table refresh history replication. More specifically, a separate log can be maintained for the refresh history for DTs in the secondary deployment. At each replication refresh, a new refresh history entry can be inserted. The replication refresh can be used as a dynamic table refresh in the secondary deployment.

### Dynamic Table DDL History/DT Dependency Graph Replication

In some aspects, DT manager 128 can configure dynamic table DDL history/DT dependency graph replication. In some aspects, DDL history can be recorded for DTs. The purpose of this history is to allow refreshes of DTs to use the correct shape of the dependency graph at the time of the tick since refreshes can be scheduled at a past timestamp and work on a different shape of the graph than the most current shape (refresh BG job can lag and catch up). The DDL history can be used to refresh.

In secondary deployments, only ticks after the failover can be scheduled. There may be no need to refresh the pipeline at a past timestamp. The only shape of the graph that refreshes can be accessed after the failover is the most recent shape of the graph. Therefore, the DDL history may not be replicated from the primary to the secondary. For simplicity, the secondary deployment can generate a new DDL entry at the time of the replication refresh, reflecting the current state of the graph, using timestamps in the timeline of the secondary deployment. In some aspects, past DDL entries can be truncated eagerly or rely on the same mechanism as in the primary to periodically compact and truncate the DDL log.

In some aspects, DT manager 128 can configure soft dependency configurations. The above behavior (not supporting replication for DT pipelines spanning multiple replication groups) may not function together with sharing use cases, where one customer A replicates a DT into another region and shares the replicated DT with another customer B. In this case, the replicated DT will be in a suspended state. If customer B creates DTs on top of the shared DT, the newly created DTs will not be able to refresh, effectively rendering them useless.

For such sharing use cases to work, a “soft dependency” concept can be introduced that disconnects DT pipelines. When customer B creates new DTs that depend on the replicated DT, they can specify the dependency to be soft dependency such that the newly created DT would treat the replicated DT as a regular base table. When the new DTs refresh, the pipeline would not resolve DTs with “soft dependency” as a node in the graph; it would merely use them as base tables.

In some aspects, using soft dependency automatically implies that the pipeline no longer sees a snapshot of all dependencies at the soft dependency edge.

The behavior of soft dependency is consistent when a part of a DT pipeline suddenly becomes read-only (due to primary failover). If that part of the pipeline is connected to the rest through soft dependencies, the rest of the pipeline can continue to work, acknowledging that a snapshot is no longer maintained. If that part of the pipeline is connected to the rest through strong dependency, any consumer of that part of the pipeline will not be able to refresh due to a suspended state. Teams operating different parts of a pipeline can freely decide if they want to connect to others through strong or soft dependencies.

In some aspects, the soft dependency behavior can be achieved by using a stream, a task, and a staging table. Such use cases can be facilitated by introducing a new syntax for creating DTs that softly depend on other DTs. One example syntax is “CREATE DYNAMIC TABLE . . . AT . . . ” which explicitly states the intent to create a dynamic table at a past timestamp, which implies that the expectation of refresh is disconnected from the current state of the dependency.

In some aspects, DT manager 128 can configure snapshot remapping. Regular tables in a database can be seen as a single snapshot at any given timestamp (all updates are made to the most recent snapshot protected by ACID transactions). As a result, the replication framework can compact multiple table versions into a single one across all tables without affecting the correctness. The relative ordering of the table version stack of one table with respect to the table version stack of another table is not significant in the secondary deployment. Stream replication creates more table versions than the most recent table version to support change queries for streams in the secondary deployment. These table versions may not be time-traveled, and they may not preserve the ordering relative to table versions of other tables in the database (only the ordering of table versions within each table is preserved).

With the introduction of dynamic tables, the database may not always be seen as a single snapshot. For a pipeline with DTs requiring different lags, the downstream of the pipeline parks at a staler snapshot (due to a larger lag), and the upstream of the pipeline parks at a more recent snapshot, and neither snapshot is the same snapshot as the rest of the database. If the multiple snapshots are collapsed into a single snapshot for the DT pipeline, performing snapshot reads that touch more than a single DT can be challenging. For example, if a query joins a DT with a regular table and computes some stats, the query will return wrong information because it is working on an inconsistent snapshot.

In some aspects, DT manager 128 can configure warehouse replication. In some aspects, the DT refresh can fail if the warehouse is not brought over. Customers can fix these DTs by recreating the warehouse with the same name after failover since DTs resolve warehouses by name.

In some aspects, database replication and failover group replication can be the same.

In some aspects, DT manager 128 can configure the following failover group (FG) and replication group (RG) state changes:
(a) Dynamic TableUserSpecifiedRefreshState (persisted):
(a.1) ACTIVE—The DT itself refreshes.
(a.2) SUSPENDED—The DT itself does not refresh.
(b) DynamicTableRefreshState (computed).
(b.1) ACTIVE—The DT itself refreshes.
(b.2) SUSPENDED—The DT itself does not refresh.
(c) Dynamic TablePipelineState (computed).
(c.1) CONNECT_WITH_DOWNSTREAM. If the DT is suspended, it also prevents the downstream from refreshing.
(c.2) DISCONNECT_WITH_DOWNSTREAM. Downstream will be able to refresh (if they are active) regardless of whether this very DT is ACTIVE or SUSPENDED.
(d) DynamicTableReplicationState (persisted; used to compute other states):
(d.1) PRIMARY.
(d.2) REPLICA_FG.
(d.3) REPLICA_RG.

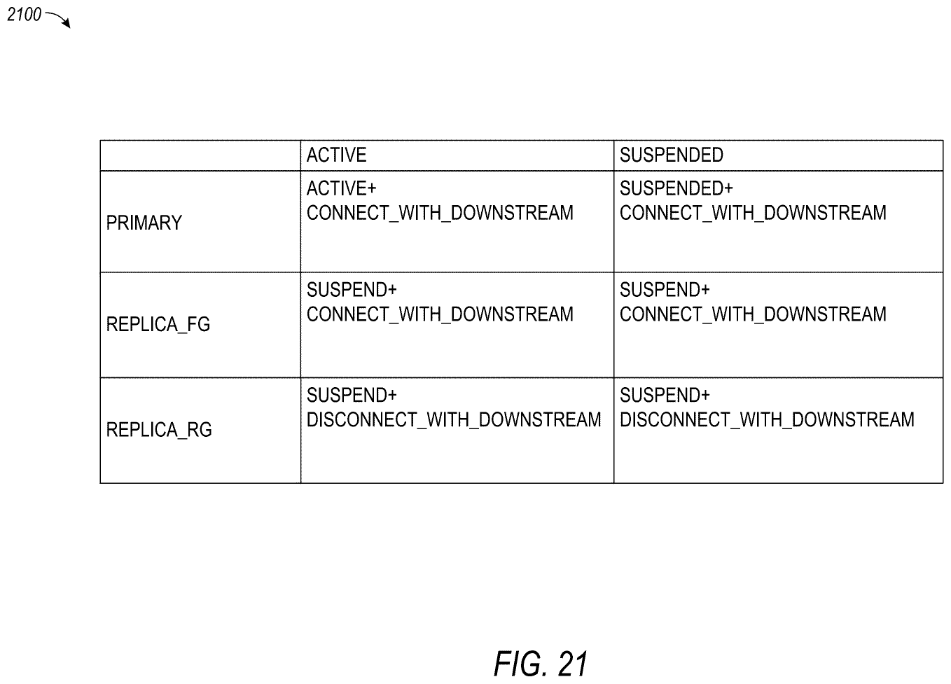

FIG. 21 illustrates table 2100 with dynamic table replication states, in accordance with some embodiments of the present disclosure. Referring to FIG. 21, table 2100 illustrates the replication states of Primary (e.g., a primary DT), Replica_FG (e.g., a replicated FG), and Replica_RG (e.g., a replicated RG). Table 2100 also illustrates the behavior for the replication states under different scheduling states (e.g., under active or suspended scheduling states).

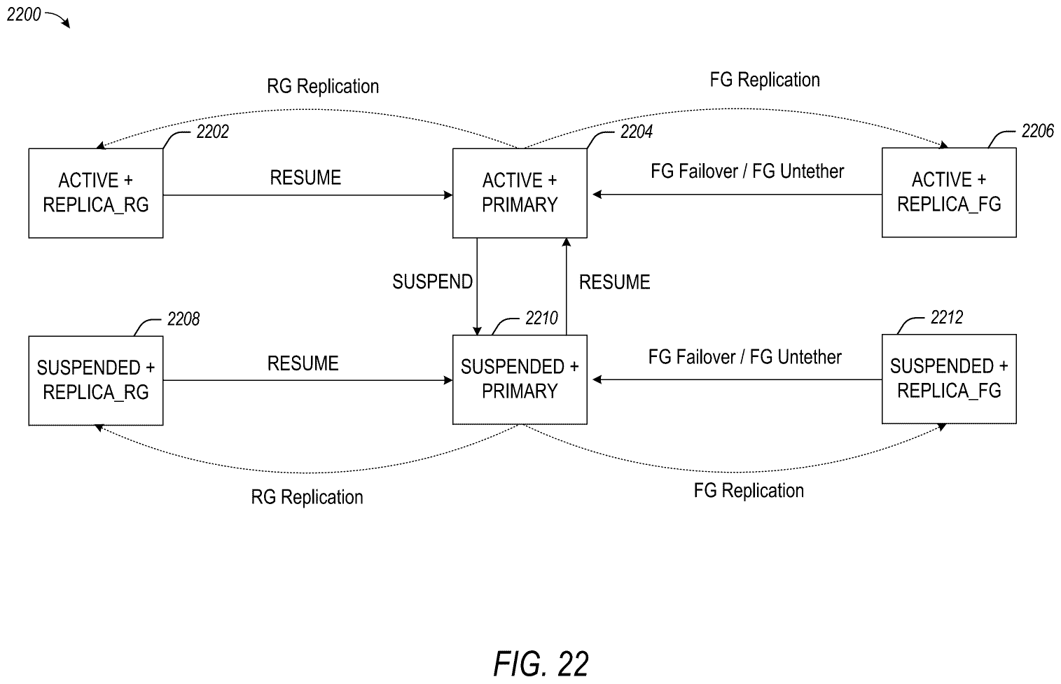

FIG. 22 is a state diagram 2200 of state transitions based on the states of FIG. 21, in accordance with some embodiments of the present disclosure. Referring to FIG. 22, state diagram 2200 illustrates the transition of active/primary state 2204 (e.g., for a primary DT) to active/replica_RG state 2202 (e.g., based on RG replication that includes the DT) or active/replica_FG state 2206 (e.g., based on FG replication that includes the DT).

State diagram 2200 also illustrates the transition between active/primary state 2204 and suspended/primary state 2210 (e.g., based on RESUME or SUSPEND commands applied to the DT).

State diagram 2200 further illustrates the transition of suspended/primary state 2210 (e.g., for a suspended primary DT) to suspended/replica_RG state 2208 (e.g., based on RG replication that includes the suspended DT) or suspended/replica_FG state 2212 (e.g., based on FG replication that includes the suspended DT).

In some aspects, DT manager 128 can configure the following functionalities associated with DT replication for non-failover use cases.

In some aspects, DT manager 128 can replicate dynamic tables into secondary deployments to support non-failover use cases.

In some aspects, DT manager 128 can configure the replicated table to behave like a regular table. The replicated table can be configured as queryable. Streams on the replicated table can be used as they do on regular tables. If the replicated DT is used as a dependency for other refreshable DTs, the replicated DT participates in the refresh as a regular base table.

In some aspects, DT manager 128 can configure use cases that chain RG/FG together to work consistently compared to using them individually. Additionally, sharing can be configured to work consistently regardless of local or remote sharing. In some aspects, chained replication use cases can be configured. In some aspects, DTs with cross-group dependencies can be replicated into the secondary through a replication group.

In some aspects, DT manager 128 can configure DT replication in a special mode that behaves like a regular (non-dynamic) table. For example, DT manager 128 can configure the replication of a dynamic table in the primary as a dynamic table in the secondary. The replicated dynamic table is put in a “hibernated” mode (e.g., it does not require a warehouse to exist, and it does not bring its dependencies when participating in a dynamic table refresh). This can be achieved by specifying a new refresh mode for dynamic tables.

In some aspects, the following configurations can be used to configure a replicated DT to behave like a regular table:
(a) The DT serves select queries from users.
(b) The DT does not participate in DT refresh pipelines. The output pipelines generated by a pipeline runner do not include this DT. As a result, when users of a replicated DT perform DT refresh, the replicated DT does not refresh.
(c) When users of the replicated DT perform a refresh, select queries used by consumers are treated the same way as regular time travel queries. Only table versions of the replicated table are resolved by the query (that has an “AT” in it), and base table versions are not resolved.

In some aspects, a user can explicitly specify “dynamic table” in the syntax prior to the name of the object, which specifications can be masked by regular table syntax such as:
(a) SHOW DYNAMIC TABLES;
(b) CREATE STREAM . . . ON DYNAMIC TABLE . . . ; and
(c) ALTER DYNAMIC TABLE . . . In some aspects, the DT behavior mentioned above can be configured in different ways. For example, a new DT state (e.g., DynamicTableState) that fully implements the specification can be introduced. Alternatively, the refresh activity of the DT can be separated from the behavior of downstream DTs. For example, a separate field can be introduced to specify if the active/suspended state affects the refresh activity of downstream DTs.

In some aspects, DT manager 128 can configure cross-group replication. For a dynamic table with dependencies that fall outside of the replication group, such replications can be performed to ensure that the replicated table is queryable. This can be considered an essential aspect of non-failover replication and a distinction between a non-failover and a failover replication for DTs. Since a pipeline is no longer maintained at the secondary site, there are no longer any special considerations about a DT regarding snapshot consistency upstream. The behaviors of replicated DTs will be similar to those of regular tables.

In some aspects, DT manager 128 can configure replication of a DT into a regular (non-dynamic) table. The following functionalities can be associated with this approach.
(a) Grants Conversion. In some aspects, grants conversion can be performed if the domain of the DT object changes in the replication refresh. Table and Dynamic tables share grants such as OWNERSHIP, SELECT, and REFERENCE (DTs do not have INSERT, DELETE, UPDATE, and TRUNCATE privileges, and tables do not have OPERATOR or MONITOR). If a dynamic table is replicated into a regular table, grant conversions can be configured.

In some aspects, there could be a security concern related to such conversions. For example, suppose a role has SELECT on all dynamic tables in the primary but not SELECT on any tables. In that case, a determination can be made on what happens in the secondary site. One option is to give SELECT on all tables so that a particular role is configured or drop all the grants.
(b) Tethering and Untethering. Suppose a user creates an RG that causes a DT in the primary deployment to be replicated into the secondary deployment as a regular table, and later, the user drops the RG and recreates an FG on the same source and destination pairs. In that case, the DT manager 128 can ensure the FG replication correctly overrides the existing regular table replica of the DT (e.g., recreate the replica table as a DT replica). In some aspects, when an RG is created in place of an FG, the correct overriding can be configured.
(c) Local share versus remote share. Local share and remote share would work differently for DTs if a DT were replicated as a regular table. More specifically, for remote share, the shared object is a regular table, whereas for local share, the shared object is a DT. Local shares do not clone local objects, and they reference the local object directly. In some aspects, the table kind for the local DT object may be left unconverted. The net effect of this functionality is that remote shares are referencing regular table objects, and local shares are referencing DT objects. To ensure that the sharing experience remains consistent for both local and remote sharing, the locally shared DT object can be masked into a regular table. Select queries can work the same between a DT and a regular table object. However, for statements such as show tables, describe the table, create stream . . . on table . . . , etc., the shared DT can be accounted as a regular table.
(d) Writable view. In some aspects, materialized data stored in a dynamic table can be the result of a query—JOINs, GROUPBYs, etc. Once the replication group is dropped (untethered), a table full of computation results remains that can be writable by the user. For example, users can directly mutate the materialized results. This is analogous to being able to write to a materialized view, which is counterintuitive to users and can be disallowed by databases.
(e) Stream on DT versus stream on a table. In some aspects, streams on dynamic tables compute row differences based on dynamic table row UUID. Streams on regular tables compute row differences based on row ID which concatenates partition name and row number together. In this regard, if the table kind is converted from a dynamic table to a regular table, stream behaviors may diverge between the primary and secondary deployments. Use cases can be verified as being able to execute under this divergence.

In some aspects, the following two approaches can be configured to achieve table-kind conversion.
(a) Change the DPOReplicationPropertyGroup of the getKindId( ) field on TableDPO from SYSTEM to CUSTOM. Configurations about FIELD_KIND_ID in replicationHandler_ValidateSystemPropOnCreate can be migrated into replicationHandler_ValidateCustomPropOnCreate (similar to replicationHandler_ValidateSystemPropOnSync). This change converts the table kind field on the destination site when applying the snapshot.

After the above changes and migrations are done, custom logic can be inserted in replicationHandler_PopulateCustomPropOnCreate and replicationHandler_PopulateCustomPropOnSync handlers to convert a dynamic table kind into a regular table kind if the replication is located in a replication group.

In some aspects, SynchronizationContext can be configured to contain enough information for the handler to determine if the replication is happening inside a replication group or a failover group.
(b) When producing the PortableDPO (a portable metadata object) for a dynamic table, a deep copy can be performed of the table metadata object, and the kind field can be changed before the table DPO is serialized into a PortableDPO. This functionality can be performed by inserting a mutating function into the function that creates a serialized PortableDPO object from the table metadata object. This achieves the table-kind conversion on the primary site before a snapshot is produced.

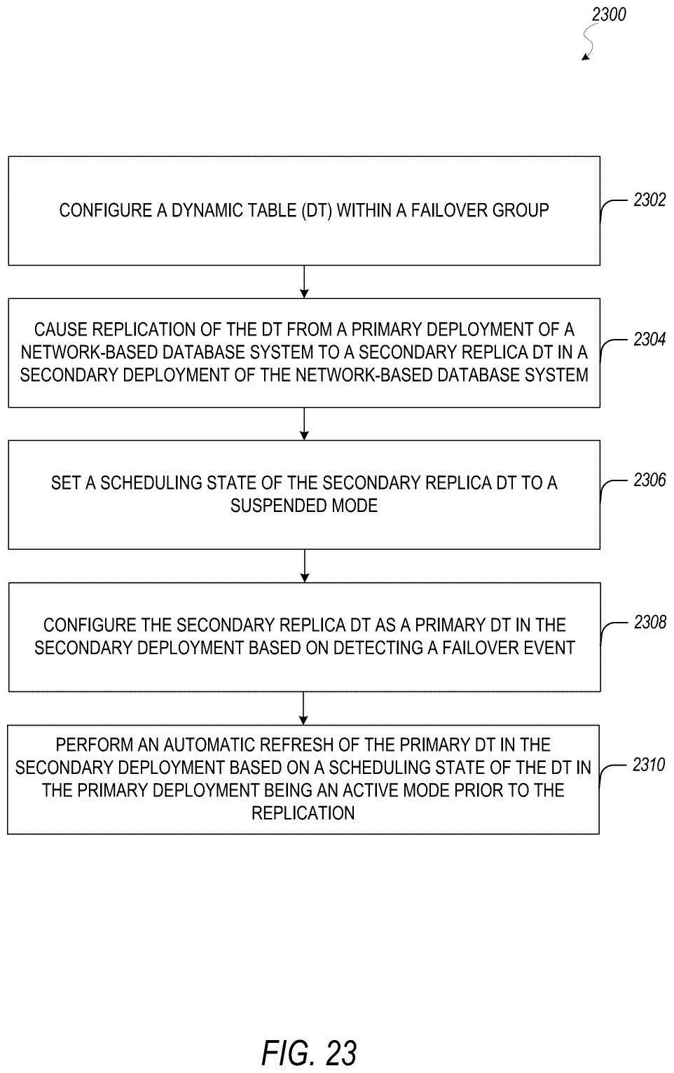

FIG. 23 is a flow diagram illustrating the operations of a database system in performing a method 2300 for replicating a dynamic table, in accordance with some embodiments of the present disclosure. Method 2300 may be embodied in computer-readable instructions for execution by one or more hardware components (e.g., one or more processors) such that the operations of method 2300 may be performed by components of network-based database system 102, such as components of the compute service manager 108 (e.g., the DT manager 128) and/or the execution platform 110 (which components may be implemented as machine 2600 of FIG. 26). Accordingly, method 2300 is described below, by way of example with reference to it. However, it should be noted that method 2300 may be deployed on various other hardware configurations and is not intended to be limited to deployment within the network-based database system 102.

At operation 2302, DT manager 128 configures a DT within a failover group.

At operation 2304, DT manager 128 performs replication of the DT from a primary deployment of a network-based database system to a secondary replica DT in a secondary deployment of the network-based database system.

At operation 2306, DT manager 128 sets a scheduling state of the secondary replica DT to a suspended mode (or a suspended state).

At operation 2308, DT manager 128 configures the secondary replica

DT as a primary DT in the secondary deployment based on detecting a failover event.

At operation 2310, DT manager 128 performs an automatic refresh of the primary DT in the secondary deployment based on a scheduling state of the DT in the primary deployment being an active mode prior to the replication.

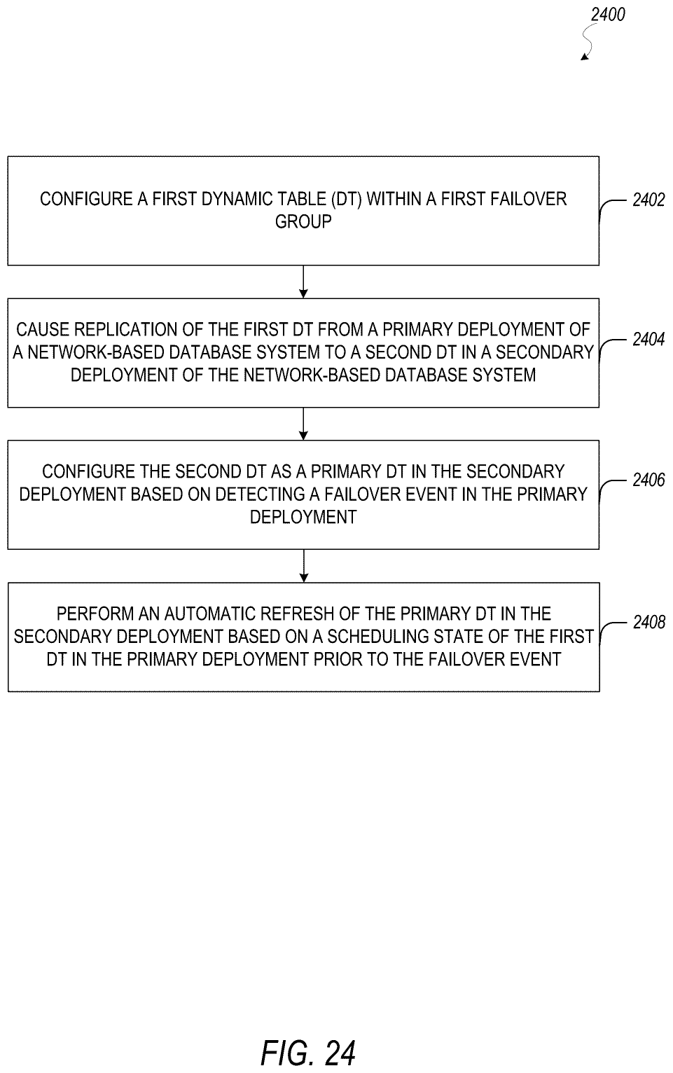

FIG. 24 is a flow diagram illustrating the operations of a database system in performing method 2400 for replicating a dynamic table, in accordance with some embodiments of the present disclosure. Method 2400 may be embodied in computer-readable instructions for execution by one or more hardware components (e.g., one or more processors) such that the operations of method 2400 may be performed by components of network-based database system 102, such as components of the compute service manager 108 (e.g., the DT manager 128) and/or the execution platform 110 (which components may be implemented as machine 2600 of FIG. 26). Accordingly, method 2400 is described below, by way of example with reference to it. However, it should be noted that method 2400 may be deployed on various other hardware configurations and is not intended to be limited to deployment within the network-based database system 102.

At operation 2402, DT manager 128 configures a first DT within a first failover group.

At operation 2404, DT manager 128 causes replication of the first DT from a primary deployment of a network-based database system to a second DT in a secondary deployment of the network-based database system.

At operation 2406, DT manager 128 configures the second DT as a primary DT in the secondary deployment based on detecting a failover event in the primary deployment.

At operation 2408, DT manager 128 performs an automatic refresh of the primary DT in the secondary deployment based on a scheduling state of the first DT in the primary deployment prior to the failover event.

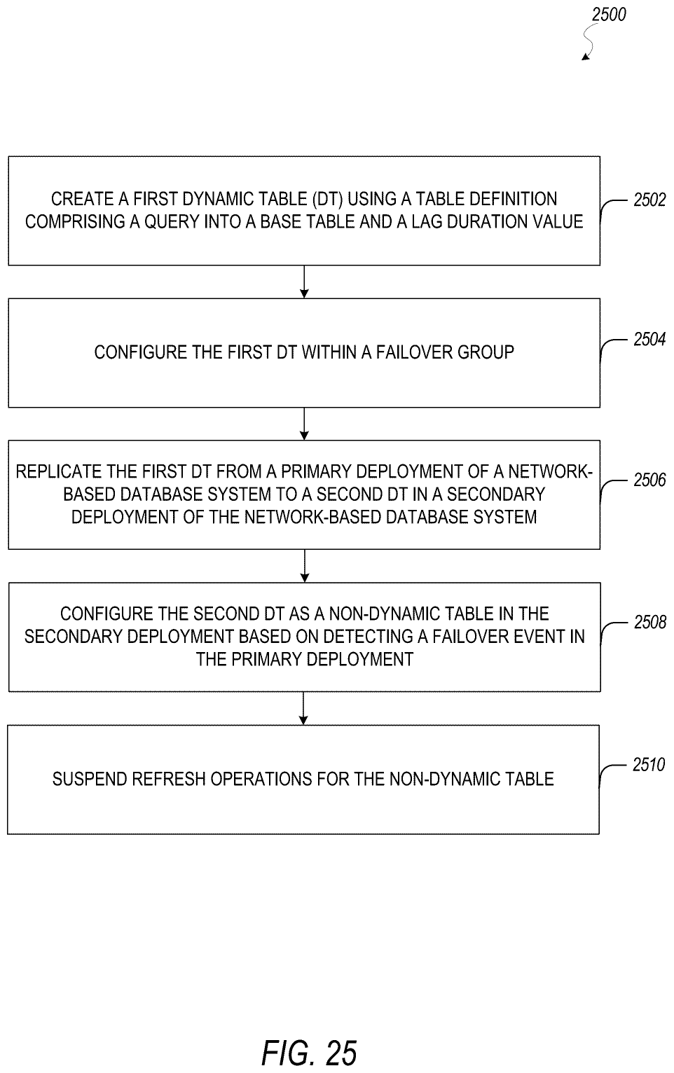

FIG. 25 is a flow diagram illustrating the operations of a database system in performing method 2500 for replicating a dynamic table for a non-failover use case, in accordance with some embodiments of the present disclosure. Method 2500 may be embodied in computer-readable instructions for execution by one or more hardware components (e.g., one or more processors) such that the operations of method 2500 may be performed by components of network-based database system 102, such as components of the compute service manager 108 (e.g., the DT manager 128) and/or the execution platform 110 (which components may be implemented as machine 2600 of FIG. 26). Accordingly, method 2500 is described below, by way of example with reference to it. However, it should be noted that method 2500 may be deployed on various other hardware configurations and is not intended to be limited to deployment within the network-based database system 102.

At operation 2502, DT manager 128 creates a first DT using a table definition. The table definition includes a query into a base table and a lag duration value. The lag duration value indicates a maximum time period that a result of a prior refresh of the query lags behind a current time instance.

At operation 2504, DT manager 128 configures the first DT within a failover group.

At operation 2506, DT manager 128 replicates the first DT from a primary deployment of a network-based database system to a second DT in a secondary deployment of the network-based database system.

At operation 2508, DT manager 128 configures the second DT as a non-dynamic table in the secondary deployment based on detecting a failover event in the primary deployment.

At operation 2510, DT manager 128 suspends refresh operations for the non-dynamic table.

FIG. 26 illustrates a diagrammatic representation of a machine 2600 in the form of a computer system within which a set of instructions may be executed to cause the machine 2600 to perform any one or more of the methodologies discussed herein, according to an example embodiment. Specifically, FIG. 26 shows a diagrammatic representation of machine 2600 in the example form of a computer system, within which instructions 2616 (e.g., software, a program, an application, an applet, an app, or other executable code) for causing the machine 2600 to perform any one or more of the methodologies discussed herein may be executed. For example, instructions 2616 may cause machine 2600 to execute any one or more operations of method 2300, method 2400, and method 2500 (or any other technique discussed herein, for example, in connection with FIG. 4-FIG. 25). As another example, instructions 2616 may cause machine 2600 to implement one or more portions of the functionalities discussed herein. In this way, instructions 2616 may transform a general, non-programmed machine into a particular machine 2600 (e.g., the compute service manager 108 or a node in the execution platform 110) that is specially configured to carry out any one of the described and illustrated functions in the manner described herein. In yet another embodiment, instructions 2616 may configure the compute service manager 108 and/or a node in the execution platform 110 to carry out any one of the described and illustrated functions in the manner described herein.

In alternative embodiments, the machine 2600 operates as a standalone device or may be coupled (e.g., networked) to other machines. In a networked deployment, machine 2600 may operate in the capacity of a server machine or a client machine in a server-client network environment or as a peer machine in a peer-to-peer (or distributed) network environment. The machine 2600 may comprise, but not be limited to, a server computer, a client computer, a personal computer (PC), a tablet computer, a laptop computer, a netbook, a smartphone, a mobile device, a network router, a network switch, a network bridge, or any machine capable of executing the instructions 2616, sequentially or otherwise, that specify actions to be taken by the machine 2600. Further, while only a single machine 2600 is illustrated, the term “machine” shall also be taken to include a collection of machines 2600 that individually or jointly execute the instructions 2616 to perform any one or more of the methodologies discussed herein.

Machine 2600 includes processors 2610, memory 2630, and input/output (I/O) components 2650 configured to communicate with each other, such as via a bus 2602. In some example embodiments, the processors 2610 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 2612 and a processor 2614 that may execute the instructions 2616. The term “processor” is intended to include multi-core processors 2610 that may comprise two or more independent processors (sometimes referred to as “cores”) that may execute instructions 2616 contemporaneously. Although FIG. 26 shows multiple processors 2610, machine 2600 may include a single processor with a single core, a single processor with multiple cores (e.g., a multi-core processor), multiple processors with a single core, multiple processors with multiple cores, or any combination thereof.

The memory 2630 may include a main memory 2632, a static memory 2634, and a storage unit 2636, all accessible to the processors 2610, such as via the bus 2602. The main memory 2632, the static memory 2634, and the storage unit 2636 store the instructions 2616, embodying any one or more of the methodologies or functions described herein. The instructions 2616 may also reside, wholly or partially, within the main memory 2632, within the static memory 2634, within machine storage medium 2638 of the storage unit 2636, within at least one of the processors 2610 (e.g., within the processor's cache memory), or any suitable combination thereof, during execution thereof by the machine 2600.

The I/O components 2650 include components to receive input, provide output, produce output, transmit information, exchange information, capture measurements, and so on. The specific I/O components 2650 that are included in a particular machine 2600 will depend on the type of machine. For example, portable machines such as mobile phones will likely include a touch input device or other such input mechanisms. In contrast, a headless server machine will likely not include such a touch input device. It will be appreciated that the I/O components 2650 may include many other components that are not shown in FIG. 26. The I/O components 2650 are grouped according to functionality merely to simplify the following discussion, and the grouping is in no way limiting. In various example embodiments, the I/O components 2650 may include output components 2652 and input components 2654. The output components 2652 may include visual components (e.g., a display such as a plasma display panel (PDP), a light-emitting diode (LED) display, a liquid crystal display (LCD), a projector, or a cathode ray tube (CRT)), acoustic components (e.g., speakers), other signal generators, and so forth. The input components 2654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures or other tactile input components), audio input components (e.g., a microphone), and the like.

Communication may be implemented using a wide variety of technologies. The I/O components 2650 may include communication components 2664, operable to couple the machine 2600 to a network 2680 or devices 2670 via a coupling 2682 and a coupling 2672, respectively. For example, the communication components 2664 may include a network interface component or another suitable device to interface with network 2680. In further examples, communication components 2664 may include wired communication components, wireless communication components, cellular communication components, and other communication components to provide communication via other modalities. The device 2670 may be another machine or any of a wide variety of peripheral devices (e.g., a peripheral device coupled via a universal serial bus (USB)). For example, as noted above, machine 2600 may correspond to any one of the compute service manager 108 or the execution platform 110, and device 2670 may include the client device 114 or any other computing device described herein as being in communication with the network-based database system 102 or the cloud storage platform 104.

The various memories (e.g., 2630, 2632, 2634, and/or memory of the processor(s) 2610 and/or the storage unit 2636) may store one or more sets of instructions 2616 and data structures (e.g., software) embodying or utilized by any one or more of the methodologies or functions described herein. These instructions 2616, when executed by the processor(s) 2610, cause various operations to implement the disclosed embodiments.

As used herein, the terms “machine-storage medium,” “device-storage medium,” and “computer-storage medium” mean the same thing and may be used interchangeably in this disclosure. The terms refer to single or multiple storage devices and/or media (e.g., a centralized or distributed database and/or associated caches and servers) that store executable instructions and/or data. The terms shall accordingly be taken to include, but not be limited to, solid-state memories and optical and magnetic media, including memory internal or external to processors. Specific examples of machine-storage media, computer-storage media, and/or device-storage media include non-volatile memory, including by way of example, semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 2680 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, network 2680 or a portion of network 2680 may include a wireless or cellular network, and coupling 2682 may be a Code Division Multiple Access (CDMA) connection, a Global System for Mobile communications (GSM) connection, or another type of cellular or wireless coupling. In this example, the coupling 2682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 2616 may be transmitted or received over network 2680 using a transmission medium via a network interface device (e.g., a network interface component included in the communication components 2664) and utilizing any one of several well-known transfer protocols (e.g., hypertext transfer protocol (HTTP)). Similarly, instructions 2616 may be transmitted or received using a transmission medium via coupling 2672 (e.g., a peer-to-peer coupling) to device 2670. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 2616 for execution by the machine 2600 and includes digital or analog communications signals or other intangible media to facilitate communication of such software. Hence, the terms “transmission medium” and “signal medium” shall be taken to include any form of a modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some example embodiments, the processor or processors may be located in a single location (e.g., within a home environment, an office environment, or a server farm). In contrast, in other embodiments, the processors may be distributed across several locations.

Described implementations of the subject matter can include one or more features, alone or in combination, as illustrated below by way of examples.

Example 1 is a system comprising: at least one hardware processor; and at least one memory storing instructions that cause the at least one hardware processor to perform operations comprising: configuring a first dynamic table (DT) within a first failover group; causing replication of the first DT from a primary deployment of a network-based database system to a second DT in a secondary deployment of the network-based database system; configuring the second DT as a primary DT in the secondary deployment based on detecting a failover event in the primary deployment; and performing an automatic refresh of the primary DT in the secondary deployment based on a scheduling state of the first DT in the primary deployment prior to the failover event.

In Example 2, the subject matter of Example 1 includes subject matter such as creating the first DT using a table definition, the table definition comprising a query into a first base table and a lag duration value, the lag duration value indicating a maximum time period that a result of a prior refresh of the query lags behind a current time instance.

In Example 3, the subject matter of Example 2 includes subject matter such as performing the automatic refresh as an incremental refresh of the primary DT in the secondary deployment, the incremental refresh based on a delta of the first base table between a time of the replication and a time of the failover event.

In Example 4, the subject matter of Examples 1-3 includes subject matter such as configuring a replication state of the second DT, the replication state indicating the second DT is one of a replica DT of the first DT or the primary DT.

In Example 5, the subject matter of Example 4 includes subject matter such as setting a scheduling state of the second DT to be the same as the scheduling state of the first DT, wherein the scheduling state is one of an active state and a suspended state.

In Example 6, the subject matter of Example 5 includes subject matter such as suspending refreshes of the second DT based on the replication state of the second DT being the replica DT.

In Example 7, the subject matter of Examples 5-6 includes subject matter such as activating refreshes of the second DT based on the replication state of the second DT being the primary DT and the scheduling state of the second DT being the active state.

In Example 8, the subject matter of Examples 2-7 includes subject matter such as configuring the first failover group with a first database, the first database including the first DT and the first base table; and replicating the first database to a second database in the secondary deployment of the network-based database system, the second database including the second DT and a second base table, the second base table being a replica of the first base table.

In Example 9, the subject matter of Example 8 includes subject matter such as revising an input edge of the second base table based on a name of the second database, the name of the second database being different than a name of the first database.

In Example 10, the subject matter of Examples 2-9 includes subject matter such as configuring a second failover group with the first base table; generating a second base table as a replica of the first base table based on the failover event; truntruncating the primary DT to a DT version having a table creation time that is common with a table creation time of a base table version for the second base table; and performing an incremental refresh of the primary DT based on a delta of the second base table posted after the common table creation time.

Example 11 is a method comprising: configuring, by at least one hardware processor, a first dynamic table (DT) within a first failover group; causing replication of the first DT from a primary deployment of a network-based database system to a second DT in a secondary deployment of the network-based database system; configuring the second DT as a primary DT in the secondary deployment based on detecting a failover event in the primary deployment; and performing an automatic refresh of the primary DT in the secondary deployment based on a scheduling state of the first DT in the primary deployment prior to the failover event.

In Example 12, the subject matter of Example 11 includes, creating the first DT using a table definition, the table definition comprising a query into a first base table and a lag duration value, the lag duration value indicating a maximum time period that a result of a prior refresh of the query lags behind a current time instance.

In Example 13, the subject matter of Example 12 includes, performing the automatic refresh as an incremental refresh of the primary DT in the secondary deployment, the incremental refresh based on a delta of the first base table between a time of the replication and a time of the failover event.

In Example 14, the subject matter of Examples 11-13 includes, configuring a replication state of the second DT, the replication state indicating the second DT is one of a replica DT of the first DT or the primary DT.

In Example 15, the subject matter of Example 14 includes, setting a scheduling state of the second DT to be the same as the scheduling state of the first DT, wherein the scheduling state is one of an active state and a suspended state.

In Example 16, the subject matter of Example 15 includes, suspending refreshes of the second DT based on the replication state of the second DT being the replica DT.

In Example 17, the subject matter of Examples 12-16 includes, configuring the first failover group with a first database, the first database including the first DT and the first base table; and replicating the first database to a second database in the secondary deployment of the network-based database system, the second database including the second DT and a second base table, the second base table being a replica of the first base table.

In Example 17, the subject matter of Example 17 includes, revising an input edge of the second base table based on a name of the second database, the name of the second database being different than a name of the first database.

In Example 19, the subject matter of Examples 12-18 includes, configuring a second failover group with the first base table; generating a second base table as a replica of the first base table based on the failover event; truncating the primary DT to a DT version having a table creation time that is common with a table creation time of a base table version for the second base table; and performing an incremental refresh of the primary DT based on a delta of the second base table posted after the common table creation time.

Example 20 is a computer-storage medium comprising instructions that, when executed by one or more processors of a machine, configure the machine to perform operations comprising: configuring, by at least one hardware processor, a first dynamic table (DT) within a first failover group; causing replication of the first DT from a primary deployment of a network-based database system to a second DT in a secondary deployment of the network-based database system; configuring the second DT as a primary DT in the secondary deployment based on detecting a failover event in the primary deployment; and performing an automatic refresh of the primary DT in the secondary deployment based on a scheduling state of the first DT in the primary deployment prior to the failover event.

In Example 20, the subject matter of Example 20 includes subject matter such as creating the first DT using a table definition, the table definition comprising a query into a first base table and a lag duration value, the lag duration value indicating a maximum time period that a result of a prior refresh of the query lags behind a current time instance.

In Example 21, the subject matter of Example 21 includes subject matter such as performing the automatic refresh as an incremental refresh of the primary DT in the secondary deployment, the incremental refresh based on a delta of the first base table between a time of the replication and a time of the failover event.

In Example 23, the subject matter of Examples 20-22 includes subject matter such as configuring a replication state of the second DT, the replication state indicating the second DT is one of a replica DT of the first DT or the primary DT.

In Example 23, the subject matter of Example 23 includes subject matter such as setting a scheduling state of the second DT to be the same as the scheduling state of the first DT, wherein the scheduling state is one of an active state and a suspended state.

In Example 24, the subject matter of Example 24 includes subject matter such as suspending refreshes of the second DT based on the replication state of the second DT being the replica DT.

In Example 26, the subject matter of Examples 24-24 includes subject matter such as activating refreshes of the second DT based on the replication state of the second DT being the primary DT and the scheduling state of the second DT being the active state.

In Example 27, the subject matter of Examples 21-26 includes subject matter such as configuring the first failover group with a first database, the first database including the first DT and the first base table; and replicating the first database to a second database in the secondary deployment of the network-based database system, the second database including the second DT and a second base table, the second base table being a replica of the first base table.

In Example 27, the subject matter of Example 27 includes subject matter such as revising an input edge of the second base table based on a name of the second database, the name of the second database being different than a name of the first database.

In Example 29, the subject matter of Examples 21-28 includes subject matter such as configuring a second failover group with the first base table; generating a second base table as a replica of the first base table based on the failover event; truntruncating the primary DT to a DT version having a table creation time that is common with a table creation time of a base table version for the second base table; and performing an incremental refresh of the primary DT based on a delta of the second base table posted after the common table creation time.

In Example 30, the subject matter of Examples 15-29 includes, activating refreshes of the second DT based on the replication state of the second DT being the primary DT and the scheduling state of the second DT being the active state.

Example 31 is at least one machine-readable medium including instructions that, when executed by processing circuitry, cause the processing circuitry to perform operations to implement any of Examples 1-30.

Example 32 is an apparatus comprising means to implement any of Examples 1-30.

Example 33 is a system to implement any of Examples 1-30.

Example 34 is a method to implement any of Examples 1-30.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various embodiments. Combinations of the above embodiments and other embodiments not explicitly described herein will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to perform operations comprising:
configuring a first dynamic table (DT) within a first failover group;
causing replication of the first DT from a primary deployment of a network-based database system to a second DT in a secondary deployment of the network-based database system;
configuring the second DT as a primary DT in the secondary deployment based on detecting a failover event in the primary deployment; and
performing an automatic refresh of the primary DT in the secondary deployment based on a scheduling state of the first DT in the primary deployment prior to the failover event.

2. The system of claim 1, the operations comprising:
creating the first DT using a table definition, the table definition comprising a query into a first base table and a lag duration value, the lag duration value indicating a maximum time period that a result of a prior refresh of the query lags behind a current time instance.

3. The system of claim 2, the operations comprising:
performing the automatic refresh as an incremental refresh of the primary DT in the secondary deployment, the incremental refresh based on a delta of the first base table between a time of the replication and a time of the failover event.

4. The system of claim 1, the operations comprising:
configuring a replication state of the second DT, the replication state indicating the second DT is one of a replica DT of the first DT or the primary DT.

5. The system of claim 4, the operations comprising:
setting a scheduling state of the second DT to be same as the scheduling state of the first DT, wherein the scheduling state is one of an active state and a suspended state.

6. The system of claim 5, the operations comprising:
suspending refreshes of the second DT based on the replication state of the second DT being the replica DT.

7. The system of claim 5, the operations comprising:
activating refreshes of the second DT based on the replication state of the second DT being the primary DT and the scheduling state of the second DT being the active state.

8. The system of claim 2, the operations comprising:
configuring the first failover group with a first database, the first database including the first DT and the first base table; and
replicating the first database to a second database in the secondary deployment of the network-based database system, the second database including the second DT and a second base table, the second base table being a replica of the first base table.

9. The system of claim 8, the operations comprising:
revising an input edge of the second base table based on a name of the second database, the name of the second database being different than a name of the first database.

10. The system of claim 2, the operations comprising:
configuring a second failover group with the first base table;
generating a second base table as a replica of the first base table based on the failover event;
truncating the primary DT to a DT version having a table creation time that is common with a table creation time of a base table version for the second base table; and
performing an incremental refresh of the primary DT based on a delta of the second base table posted after the common table creation time.

11. A method comprising:
configuring, by at least one hardware processor, a first dynamic table (DT) within a first failover group;
causing replication of the first DT from a primary deployment of a network-based database system to a second DT in a secondary deployment of the network-based database system;
configuring the second DT as a primary DT in the secondary deployment based on detecting a failover event in the primary deployment; and
performing an automatic refresh of the primary DT in the secondary deployment based on a scheduling state of the first DT in the primary deployment prior to the failover event.

12. The method of claim 11, further comprising:
creating the first DT using a table definition, the table definition comprising a query into a first base table and a lag duration value, the lag duration value indicating a maximum time period that a result of a prior refresh of the query lags behind a current time instance.

13. The method of claim 12, further comprising:
performing the automatic refresh as an incremental refresh of the primary DT in the secondary deployment, the incremental refresh based on a delta of the first base table between a time of the replication and a time of the failover event.

14. The method of claim 11, further comprising:
configuring a replication state of the second DT, the replication state indicating the second DT is one of a replica DT of the first DT or the primary DT.

15. The method of claim 14, further comprising:
setting a scheduling state of the second DT to be same as the scheduling state of the first DT, wherein the scheduling state is one of an active state and a suspended state.

16. The method of claim 15, further comprising:
suspending refreshes of the second DT based on the replication state of the second DT being the replica DT.

17. The method of claim 15, further comprising:
activating refreshes of the second DT based on the replication state of the second DT being the primary DT and the scheduling state of the second DT being the active state.

18. The method of claim 12, further comprising:
configuring the first failover group with a first database, the first database including the first DT and the first base table;
replicating the first database to a second database in the secondary deployment of the network-based database system, the second database including the second DT and a second base table, the second base table being a replica of the first base table; and
revising an input edge of the second base table based on a name of the second database, the name of the second database being different than a name of the first database.

19. The method of claim 12, further comprising:
configuring a second failover group with the first base table;
generating a second base table as a replica of the first base table based on the failover event;
truncating the primary DT to a DT version having a table creation time that is common with a table creation time of a base table version for the second base table; and
performing an incremental refresh of the primary DT based on a delta of the second base table posted after the common table creation time.

20. A computer-storage medium comprising instructions that, when executed by one or more processors of a machine, configure the machine to perform operations comprising:
configuring, by at least one hardware processor, a first dynamic table (DT) within a first failover group;
causing replication of the first DT from a primary deployment of a network-based database system to a second DT in a secondary deployment of the network-based database system;
configuring the second DT as a primary DT in the secondary deployment based on detecting a failover event in the primary deployment; and
performing an automatic refresh of the primary DT in the secondary deployment based on a scheduling state of the first DT in the primary deployment prior to the failover event.
